(19) United States
(12) Patent Application Publication
(10) Pub. No.: US 2019/0114578 A1
(43) Pub. Date: Apr. 18, 2019

(54) Transportation System Using Drones For Airbourne Pickup of Parcels From Hubs and Delivery of Parcels to Hubs

(71) Applicant: Orestis Afordakos, Athens (GR)

(72) Inventor: Orestis Afordakos, Athens (GR)

(21) Appl. No.: 16/149,043

(22) Filed: Oct. 1, 2018

Related U.S. Application Data
(63) Continuation of application No. 15/999,035, filed on Aug. 20, 2018.
(60) Provisional application No. 62/566,316, filed on Sep. 29, 2017.

(51) Int. Cl. G06Q 10/08; B64C 39/02; B64D 1/02; B64D 1/22

(52) U.S. Cl. CPC G06Q 10/083; B64C 39/024; B64C 2201/128; B64D 1/22; B64D 1/02

(57) ABSTRACT

Package delivery system and methods include controller responsive drones adapted for deploying retractable tether and hook type assemblies, for pickup of parcels from designated controller responsive sending/dispatching dronespots; and includes designated controller responsive receiving dronespots, configured to deploy flexible nets adapted to catch parcels dropped from hovering drones and/or the drones themselves. Multiple drones can pick-up packages from ground locations, and deliver the packages to other geo-spatial locations, without having to land at either location for parcel pickups and deliveries.

### CROSS-REFERENCE TO RELATED APPLICATIONS

This application claims the benefit of U.S. Provisional Application No. 62/566,316, filed on Sep. 29, 2017. This application is a continuation of U.S. patent application Ser. No. 15/999,035, filed on Aug. 20, 2018, all of which is incorporated herein by reference in its entirety.

### TECHNICAL FIELD

The present invention relates generally to a system and processes for transportation of parcels from one geographic location to another by drone. More particularly, the present invention relates to computer controlled parcel pickup by drones from one ground location while the drone is still airborne, and/or delivery by drones to one or more other geo-spatial locations, while the drone is still airborne.

### I. BACKGROUND OF THE INVENTION

Over the years, a diversity of means and carriers have been used to transport items from senders to receivers at different geographic locations. E.g., historically, these have ranged from camel caravans along the Asian Silk roads, to marathon runners in ancient Greece, to Pony Express riders and bike-riding Western Union messengers in the USA. Then, in the 20^{th} century, we saw the development of huge major “Carriers” (Airborne Express, DHL, FedEx, UPS, USPS etc.). Such Carriers continue to use means such as box-trucks, acres-wide hubs, sleek B-747s and vast networks of logistics computers, to transport parcels.

In the 21^{st} century, technological advances have led to rapid growth in e-commerce. Demographically driven ongoing explosions in e-commerce and Internet purchasing are among the generators of the increasing demand for direct transit of purchases to individuals and businesses. As more consumers and enterprises have recognized the efficiencies of e-commerce, both e-tailors (Internet based retailers) and their customers have begun to rely more heavily on direct delivery of goods for e-commerce fulfillment. Billions of parcels are now being successfully transported each year. Nevertheless, reliance on parcel shipment primarily by major Carriers/couriers, using traditional transport vehicles, still presents some problems.

Delivery services (also known as: courier services, mail services, and shipping services) typically operate using a “hub and spoke” architecture. Major delivery services often maintain large fleets of vehicles, including: airplanes and semi-trailer trucks to move packages between hubs and spokes. They also operate smaller vehicles for the “last mile”, from spoke endpoints to delivery destination establishments (e.g., homes/businesses/offices). In the USA, the two largest commercial delivery services alone deploy over 100,000 last-mile vehicles, each of which requires a human operator. Moreover, forecast growth in business-to-consumer e-commerce, is expected to continue to increase the demand for delivery services and hence the need for more efficiency in last-mile operations. (E.g., see U.S. Pat. No. 9,336,506 by Shucker et al.).

### ART RECOGNIZED PROBLEMS

Kashi et al [U.S. Pat. Application No. 2016/0300187A1] notes that one of the problems with traditional parcel delivery systems is security. For example, a package delivered to a doorstep is vulnerable to theft or damage. Raptopoulos et al [Patent Application No. US 2016/0163204A1] recognizes that another problem with prior art delivery systems is congested ground infrastructure. Traditional carriers heavily rely upon these ground carriage ways which are especially crowded in cities/urban areas, where half of the earth's population now lives. High-density metropolitan areas often have ground transportation networks that have become heavily congested, and very inefficient. Ground transport inefficiencies are also evident in locations such as emerging countries, where over a billion people lack access to all-season roads.

Evolving solutions to some of these delivery problems include use of unmanned aerial vehicles (“UAV”), including drones, for package carriage.

### RELATED ART

Drone delivery of parcels, on a commercial level, could of course increase airways congestion and raise both in-air and landing safety issues. Even without new commercial drone activity, small hobbyist drone FAA registrations have been estimated to skyrocket to over 3.5 million by 2021. In addition, in early 2017, commercial drone FAA registrations were already averaging more than 30 thousand a month. On the other hand, new rules for regulating commercial UAV traffic are still under development by the FAA, lawmakers, and industry & consumer groups. Nevertheless, various types of package-delivery-by-drone systems have been proposed.

For example, suggested solutions for drone delivery of parcels include: systems for guiding parcel-carrying drones to ground landings, (e.g., see Boland et al [U.S. Pat. No. 9,471,064] and Shucker et al [cited above]); delivery to hard-body receptacles (see Soundararajan et al [Pat. Applic. No. US2016/0117934A1] and Elhawwashy [U.S. Pat. No. 9,211,025]); delivery using retractable tether type assemblies (see Burgess [U.S. Pat. No. 9,174,733]); and UAV delivery options using elevated towers as drone docking stations (see Martin et al [Pat. Application No. US2016/0033966A1]). Farris et al [Pat. Applic. No. US 2016/0033966A] suggests use of a “secure parcel box” as a “landing location” for drone delivery or pickup of a parcel. Farris posits [0044] that his secure box could be “any type of container” including an “extended net”; but he does not provide an enabling disclosure showing how to implement this suggestion.

While they may have advantages over traditional parcel transport approaches using ground infrastructures; delivery-by-drones, using apparatuses such as those above, may still be problematic. For example, one major hurdle in delivery of parcels with drones is the issue of takeoff/landing the drone for the parcel to be collected. Takeoff/landing is notoriously difficult because, at lower altitude, the wind gusts can be both pronounced and intense. Lower level gusts may be amplified by man-made structures or other ground structures. Thus, the capability for precision landing/takeoff may be reduced. This can result in drones getting blown-away and even destroyed when hitting the ground or any other hard landing/crashing surface.

Moreover, the need for precision takeoff/landing greatly increases the time for drop-offs. Landing drones may need to automatically compensate their rotor speed, (e.g., for micro-changes in the wind), thereby making their ascent/descent a time-consuming exercise. This in term further adds to the crashing/blown-away risk.

Furthermore, the need for an appropriate area for a single landing pad per landing drone means that parcels can be collected only one at a time (even with multiple pads the required safety radius between the pads increases the total space required). In situations of high volumes, drones queuing above landing pads could cause a number of issues (e.g. excess noise, risk of drones crashing on each other etc.). It can be similar to the situation at small airplane landing strips, where only one airplane may get landing clearance at a time, with the rest queuing high above.

Thus, there is a continuing need for safe, scalable, efficient, cost-effective solutions for the above indicated and other problems in the relevant (parcel-delivery-by-drones) art.

### III. SUMMARY OF THE INVENTION

The term “dronespots” (as used herein) refers to a particular type of parcel handling hub, mini-hub or “hubspot” (see cited related patent applications, by 0. Afordakos, for an electronic logistics control platform for parcel transport). These dronespots (and associated drones) are equipped with special facilities, congruent with relevant government regulation, for parcel pickup and delivery by drones.

In some embodiments, the parcel delivery system and methods disclosed herein incorporate drones which, responsive to controller signals, are configured for: flying to, and hovering over, designated first dronespots; and for deploying retractable tether and hook type assemblies for pickup of parcels from holding pads or loading structures at said first dronespots. Embodiments of the instant solution also include designated second dronespots which, responsive to controller signals, are configured to deploy flexible nets adapted to catch parcels dropped from hovering drones. Our delivery system thus allows drones to more efficiently (and safely & economically) pickup packages from one place, and safely deliver them to another geo-spatial location, without landing at either location.

In some embodiments, our solution also incorporates logic for instructing a drone to suspend hovering and drop itself onto net structures configured for catching parcels and/or the drones themselves. In some embodiments our solution includes net structures and means which allow a plurality of different drones to hover over and drop parcels to a dronespot within the same time frame.

In some embodiments our solution includes net structures and means which allow retrieval and recycling of parcels after a failed pickup attempt. In some embodiments our solution includes means and extended web structures with net-slack calculated to facilitate gravity feed of parcels to collection points. In some embodiments our solution includes netting material—suspended between poles, buildings, or other support structures—which are configured as a conveyor belt to channel parcels toward one or more collection points or retrieval containers. In some embodiments, manual/mechanical means may be used to remove parcel form the collection points.

In some embodiments our solution includes one or more controller-responsive motor apparatuses for powering winch-pulley assemblies, which are connected to net support structures. We thereby enable automatically: increasing or decreasing net height/size/extension, adjusting net-slack, and/or adjusting net depth/down-swag/slack-down. (We can thus enhance the kinetic energy absorbing properties of the parcel catching nets.) In some embodiments our solution includes manual devices/mechanical means for dynamically adjusting net configurations.

In some embodiments our solution includes devices for attaching one side of our catch-nets to a fixed spot/wall/pole, and another side to extendable/retractable roll-out pulleys. Thereby enabling coverage of relatively large areas of a backyard/terrace/roof of a dronespot. Moreover, in our solution, the net can be erected horizontally, vertically, conically or at an angle (e.g., like a “lean-to” structure attached to the side of a building).

In some embodiments our solution includes one or dronespots (“DS”) with catch-nets configurable to safely handle a plurality of parcels, and/or parcel carrying drones, which are dropped to the DS catch-nets during the same time period.

In some embodiments our solution includes on-ground signaling/marking means, for identifying the DS net area; and on-drone location detection means, for recognizing the marking means. In some means the location detection means can include image processing and/or onboard camera devices. In our solution the drone camera can also be used to facilitate computation of the drop off area on the spot to compensate for any discrepancies on rolling out the net, as well as for different net sizes and shapes.

In some embodiments our solution employs controllers which can be either: integral parts of a P2P (Peer-To-Peer) logistic control means for a parcel delivery system; server means at/connected to a separate network of first and second dronespots; and/or computer means at independent/remote third party (“P3”) sites.

In some embodiments our solution includes facilities at said second dronespots for parking, safely docking, securing, and/or repairing delivery drones.

In some embodiments our solution includes means at said second dronespots for recharging and/or refueling power sources, and/or for storing and repairing drones.

These and other aspects, objects, features and advantages of the exemplary embodiments will become apparent to a person ordinarily skilled in the art (i.e., a “POSITA”) upon consideration of the following Detailed Description of illustrated exemplary embodiments. The Summary and Abstract sections may set forth one or more but not all exemplary embodiments of the present invention as contemplated by the inventor(s); thus, they are not intended to limit the present invention and the appended claims in any way.

It is to be appreciated that the Detailed Description sections, and not just the Summary and Abstract sections, are intended to be used to interpret the claims.

### IV. BRIEF DESCRIPTION OF THE DRAWINGS

FIG. 1 is an overview block diagram overview of an embodiment of the disclosed drone delivery system.

FIG. 2 illustrates an overview block diagram of a logistics platform, for a package handling service, which might be used in conjunction with the disclosed drone delivery system.

FIG. 3 is a block diagram illustrating an exemplary Dronespot (“DS”) with parcel dispatching components.

FIG. 4 is a block diagram illustrating an exemplary dronespot with parcel catching components.

FIG. 5 is a flowchart illustrating DS controller logical operations used to prepare flight plans for drones used to pick up packages from a dronespot.

FIGS. 6A and 6B are flowcharts illustrating drone and dronespot interaction during the parcel pickup process.

FIGS. 7A, 7B & 7C are comparison illustrations of a parcel holding pad/drone landing structure which does not have mechanisms for automated parcel pickup.

FIG. 8 illustrates an overhead plan view of the inventive parcel holding structure, at a dronespot, which does have mechanisms for facilitating automated parcel pickup. The DS shown further includes a height adjustable conveyor belt, under the parcel; a Failed attachment drop area (“Recovery Box”), for parcel reprocessing; and a Pickup Control Unit (“PCU”).

FIG. 9 illustrates a section view [Phase B] of a DS, as in FIG. 7, which is being approached by a drone equipped with parcel pickup mechanisms.

FIG. 10 illustrates a section view [Phase B] of DS guidelines and a drone with its winch tether/line and parcel attachment mechanism being lowered toward the parcel holding DS.

FIG. 11 illustrates a section view [Phase C] of a drone maneuvering its parcel-grabber into position following line and ramp guides.

FIG. 12 shows a section view [Phase D] illustrating adjustments of the winch mechanism by the drone and height adjustments of a conveyor belt at the DS.

FIG. 13 shows a section view [Phase E] the drone parcel-grabber hooking a parcel at the DS.

FIG. 14 shows a section view [Phase F] of the drone tilting the parcel to ensure safe hooking and keeping tension on the hook.

FIG. 15 illustrates shows a section view [Phase G] of DS conveyor belt moving parcel out of guides and drone winch winding any slack.

FIG. 16 illustrates a section view [Phase H] of a drone hovering over the Failed attachment area (to which the parcel could drop if anything goes wrong) while it winches up and reels in a parcel that it has lifted from the DS.

FIG. 17 illustrates a section view [Phase I] of a drone secures its parcel and flies away from dispatching DS.

FIG. 18 is a flowchart illustrating an embodiment where a drone drops off a parcel at a dronespot.

FIG. 19 illustrates an overhead view of a first backyard embodiment of a dronespot where a mesh net (used for parcel catching) is rolled-up.

FIG. 20A is a flowchart illustrating catch-net deployment.

FIG. 20B is a flowchart illustrating queue handling.

FIG. 20C is a flowchart illustrating embodiments with dronespots capable of handling plural parcel drops from plural drones during the same time period.

FIG. 21 illustrates shows view from above of a first backyard embodiment of a dronespot with a rolled-out net configured for feeding of dropped parcel from the catch-net to a single collection point.

FIG. 22 illustrates a view from the side of a first backyard embodiment of a dronespot with a rolled-out net configured for feeding of dropped parcel to a single collection point.

FIG. 23 is a flowchart illustrating an embodiment where both the drone and parcel are dropped together at a dronespot with a single collection point.

FIG. 24 is a flowchart illustrating an embodiment with both parcel and drone drop-offs at a dronespot with plural collection points.

FIG. 25 illustrates a view from the above of a second backyard embodiment of a dronespot, with net rolled-up, configured with twin/multiple collections points and some poles replaced by wall mounted hooks.

FIG. 26 illustrates a view from the above of a second backyard embodiment of a dronespot, with net rolled-up configured with twin/multiple collections points and some poles replaced by wall mounted hooks.

FIG. 27 illustrates a view from the side of a second backyard embodiment of a dronespot, with net rolled out, with some poles replaced by wall mounted hooks, and configured with twin/multiple collections points under slacked deployed net.

FIG. 28 illustrates a Section view of a parcel pickup (attachment) system for small and big boxes.

FIG. 29 illustrates a section view box pickup attachment system—plan view without the net (for clarity).

FIG. 30 illustrates a box pickup attachment system—plan view with the net.

FIG. 31 illustrates a section view of a box feeder system—(pickup belt waiting to be fed).

FIG. 32 [illustrates a plan view of a box feeder system—(pickup belt waiting to be fed).

FIG. 33 illustrates a Section view of a box feeder system—positioning the box.

FIG. 34 illustrates a plain view of a box feeder system—box positioned.

FIG. 35 illustrates a section view illustrates of a box feeder system—box positioned and hooked.

FIG. 36 illustrates a section view box feeder system—box failed to attach.

FIG. 37 is a legend table identifying some of the symbols used on the above figures.

Those skilled in the art will recognize and understand that the illustrated systems and processes (indicated above) may be comprised of a plurality of physically distinct elements/routines as is suggested by the illustrations. It is also known in the art, however, to view these illustrations as comprising a logical view; in which case, one or more of these elements/routines can be enabled and realized via shared or distributed networks of electronic communication and computing resources.

### Glossary of Terms, Abbreviations & Definitions

Hs=hubspot/depot/way station temporarily holding/storing parcels.
DS=Dronespots=Hs with specialized facilities for handling drones.
DSC=Dronespot System Controller—which includes digital database, digital server, & I/O (input/output) interface elements.
DCU=Dropoff Control Unit
PCU=Pickup Control Unit
TCN=Telecommunication Network—which can include Cloud, Internet, RF channels, and other telecommunications systems—which can be used for interactions within our drone delivery system, and interactions with third party (“P3”) providers of resources (e.g., weather forecasts, GPS data, etc.).
UAV=Unmanned aerial devices.
UAS=Unmanned aerial system. The terms “UAV”, “UAS”, and “drones” are used interchangeably herein.
Parcel/package/payload=terms used interchangeability for objects being carried among geographic points.
GPS=Global Positioning System.
QR=Quick Reference bar codes.
AR=Augmented Reality=a real-time direct or indirect view of a physical real-world environment that has been enhanced/augmented by adding virtual computer generated information to it, thereby combining both real and virtual objects. (For further insight into the type of AR devices we use, see U.S.Provisional Application No. 62/547,722 filed 18 Aug. 2017 (Afordakas) which has been incorporated herein by reference.)
MLM=Machine Learning module—Our MLM uses artificial intelligence (AI) algorithms to combine information such as: historical and current geospatial, time, DS usage and capabilities, and DS administrator data, to generate parcel pickup and dropoff parameters.
DS Agent=the owner/operator/administrator of a given dronespot. These terms are used interchangeability herein.
“Artisan”, “routineer”, and “POSITA” are terms used interchangeably, herein, to denote persons of ordinary skill in the art.

### V. DETAILED DESCRIPTION

Note that the words “parcel”, “package”, and payload are used interchangeably herein. The terms “unmanned aerial device”, “UAV”, “unmanned aerial systems, “UAS”, and “drones” are used interchangeably herein. The terms “artisan”, “routineer”, and “POSITA interchangeably herein.)

One reason that drones are being targeted for use as parcel delivery machines is that drones are not only adaptable and relatively inexpensive to manufacture, but they are also typically small and lightweight. Such benefits maybe somewhat offset by some related vulnerabilities such as wind drift and other guidance issues while landing. For example: where a relatively small drone landing pad situated on a hard surface area (such as dirt, asphalt, cement etc.), this presents the issues of:

a) Risk to the drone and parcel (due to crashing probability while landing).
b) Slowdown of delivery process due to ascent/descent maneuvering.
c) Inability to collect and process multiple parcels at the same time (i.e. one pad for one drone each time).
d) Queuing issues as described above.

The solution we have devised to these issues uses qualified dronespots for parcel delivery. As noted above, the term “dronespots” refers to a particular type of parcel handling hub, mini-hub or “hubspot” [See cited related Afordakos'722 application (for an electronic logistics control platform for parcel transport)]; which have been adapted for handling drones. These special qualified hubspots/dronespots meet all relevant government rules, regulations and laws. Rather than using pads for landing parcel-carrying drones, however, these dronespots are adapted to deploy specially designed nets, a calculated number of meters above the ground, to catch dropped parcels and/or delivery drones themselves. [Think of a fishing net.]

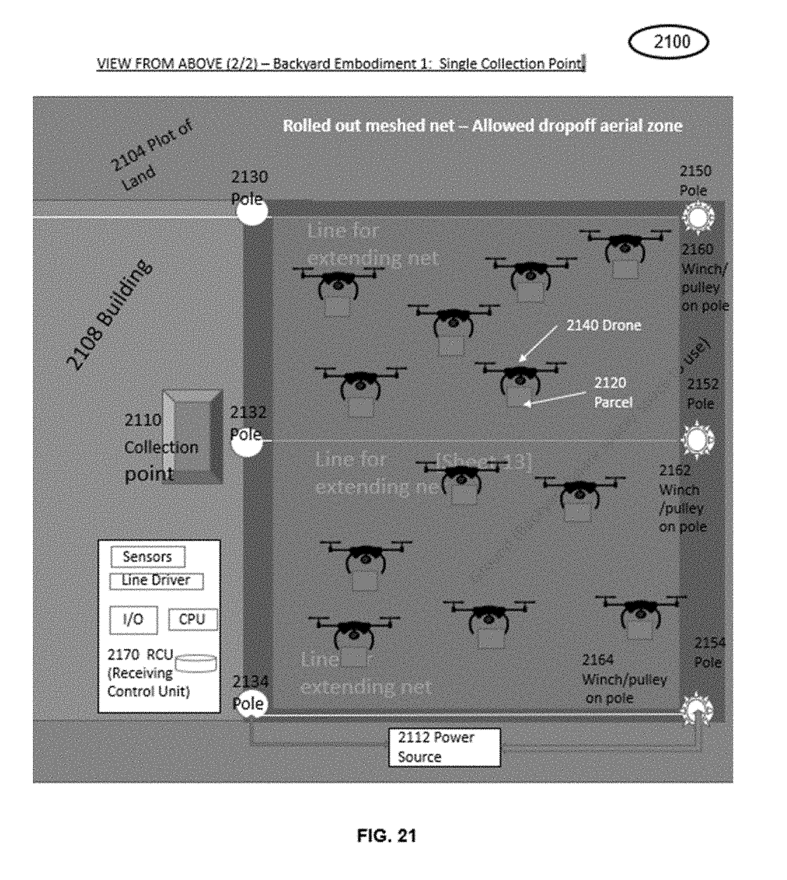

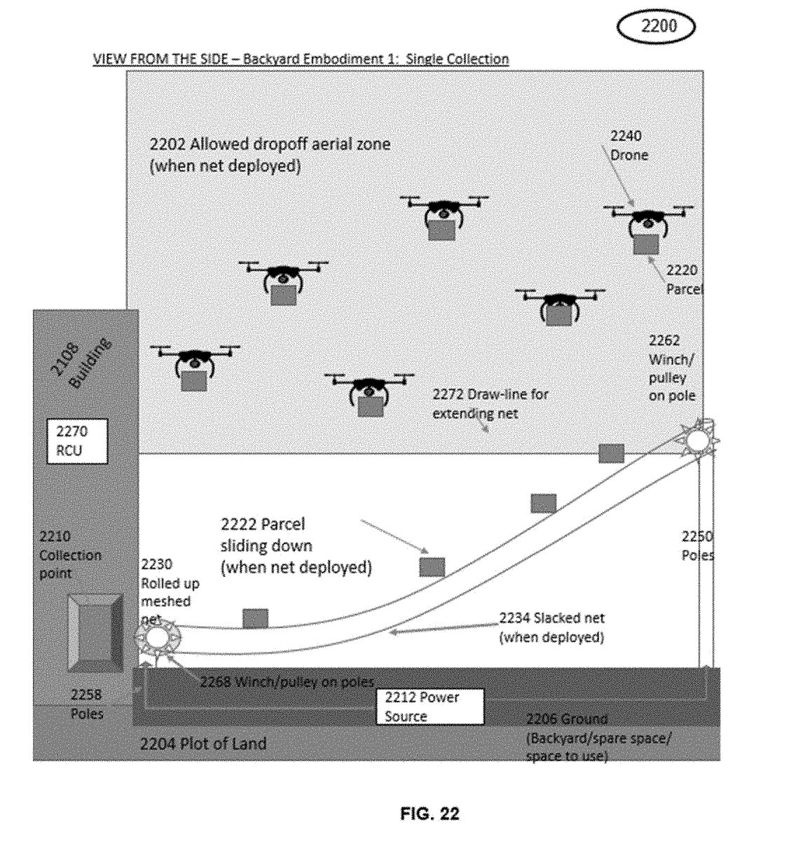

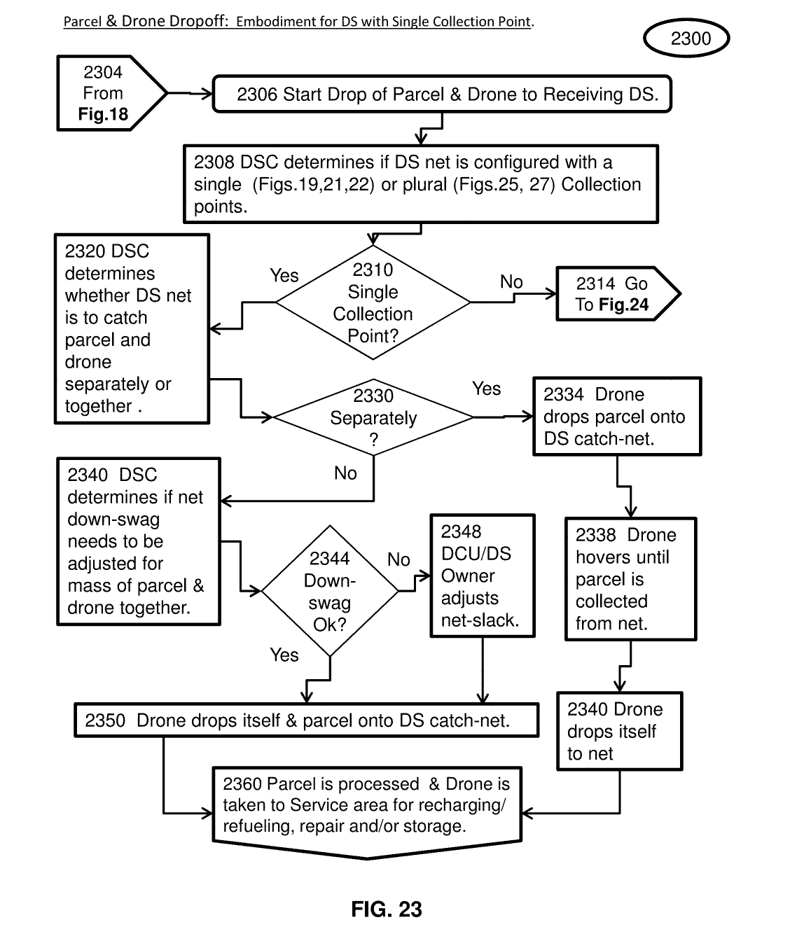

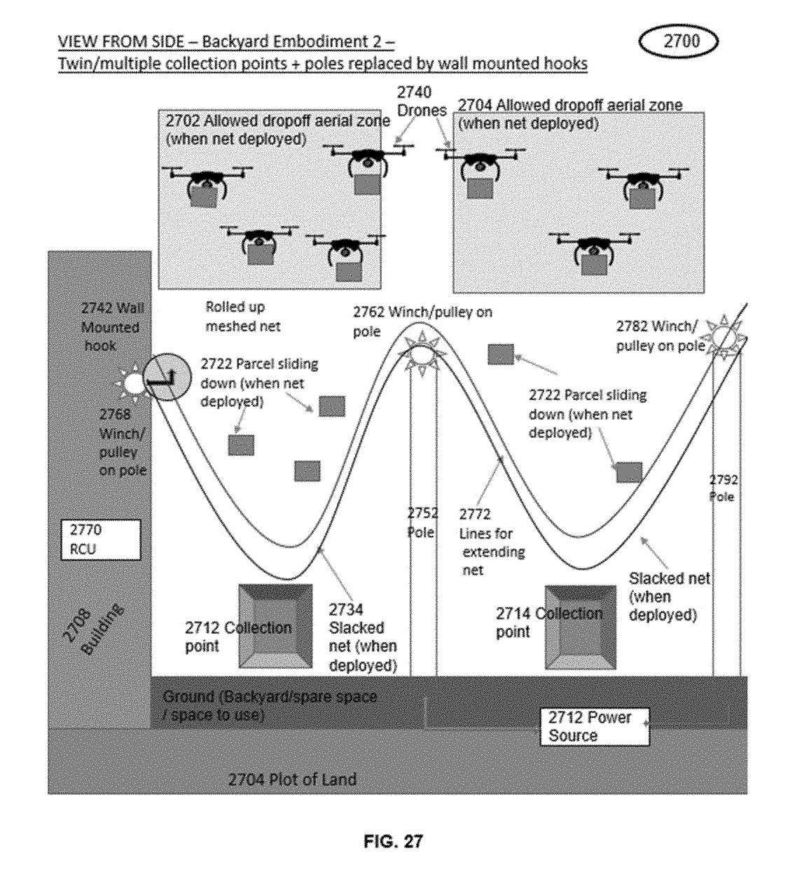

To elaborate: by deploying a net made out of a soft and durable material (for example, nylon would do just fine) the drones fly over the dronespot, and instead of stopping for descent and then re-ascent, they can simply drop the parcels above the net. See FIGS. 21-22. The net has the appropriate slack to allow for ‘slack down’ when receiving a parcel so as to absorb the kinetic energy and not cause damage to the product. [As to what is meant by ‘slack down’ please see here: (https://www.youtube.com)/watch?v=LUUeBRZ-lOg). See also FIG. 27.

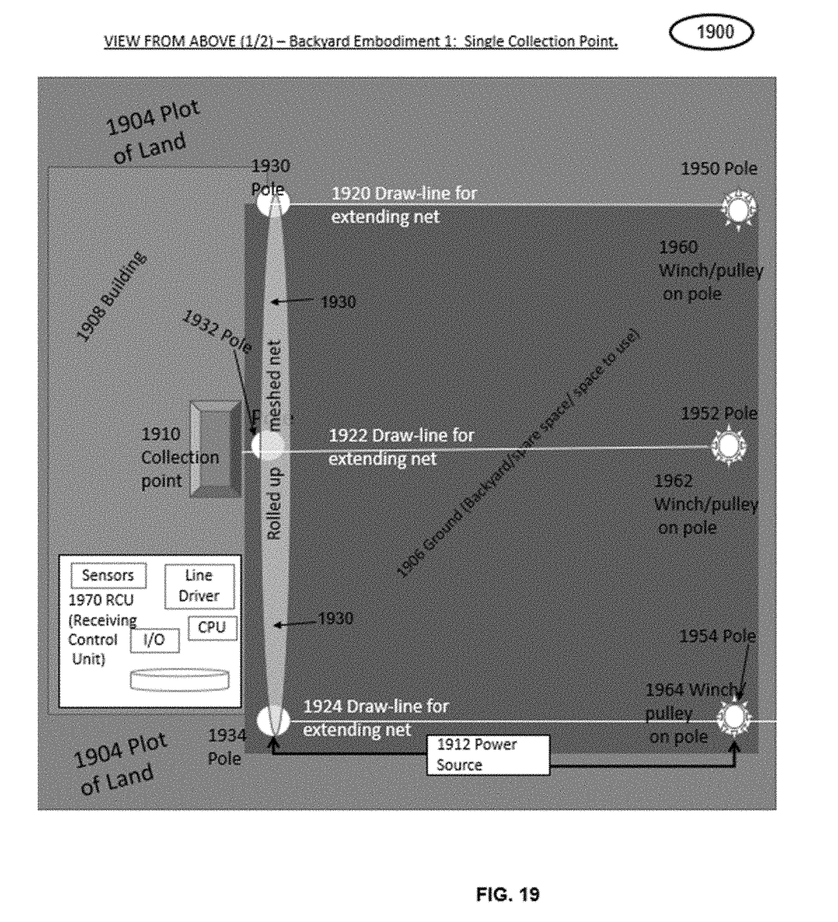

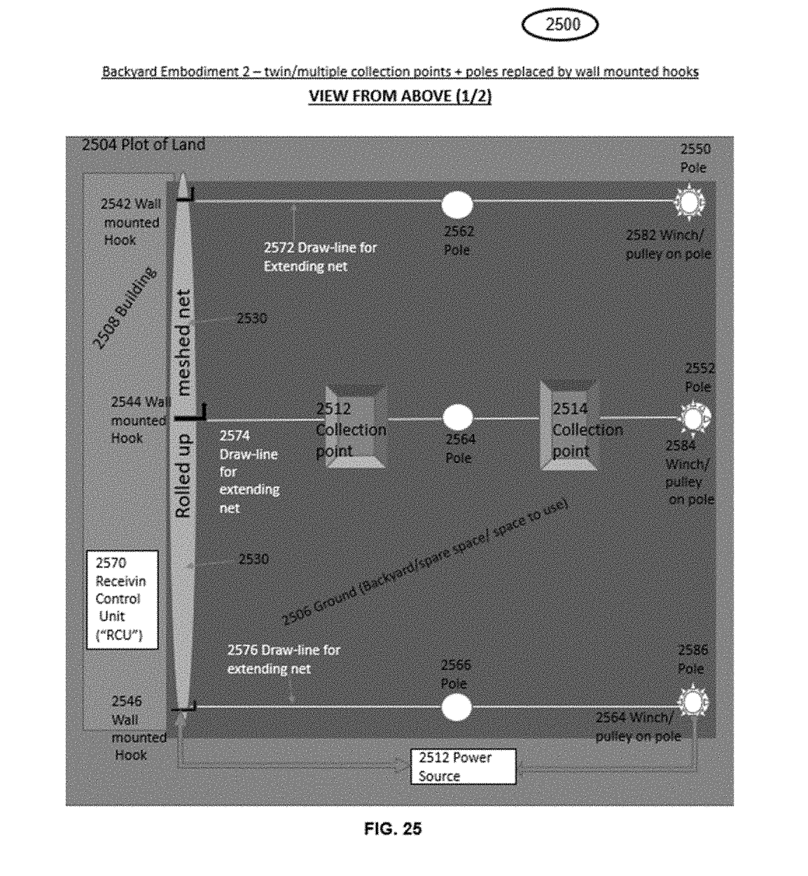

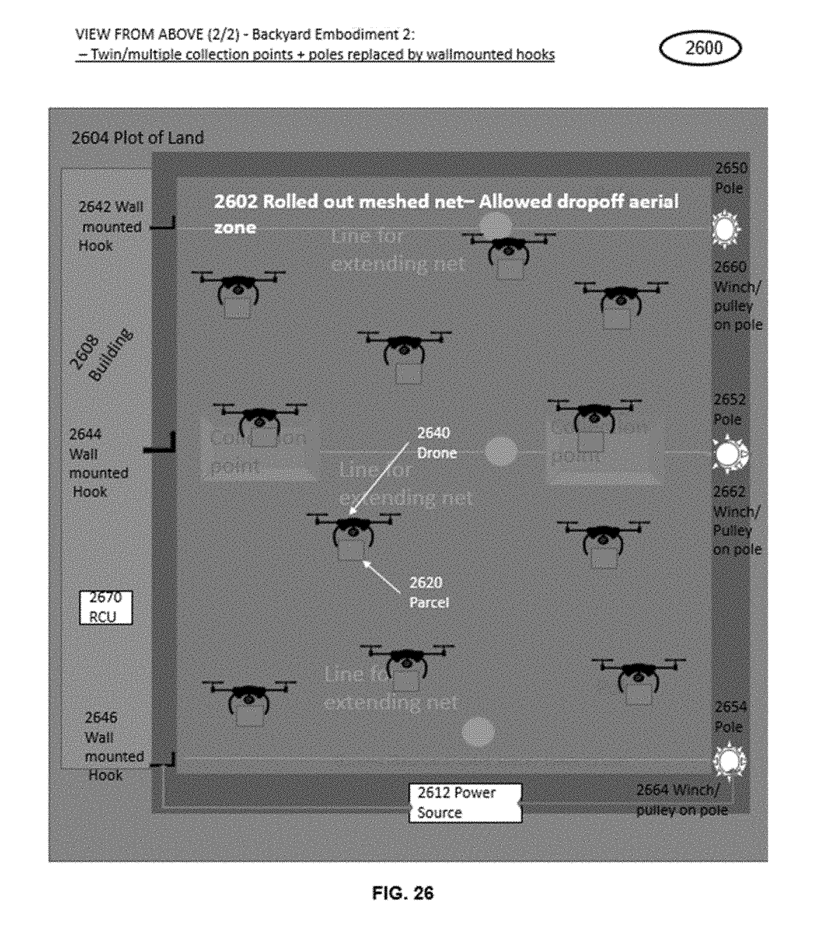

In some embodiments, the net can be a manually deployed net (on poles) and/or an automatically rolling out net., see FIG. 19. In some embodiments, the roller side can be attached to a fixed spot/wall/poles and the other side can have a device for operating the roll out pulleys—much like an automatic pool cover albeit at a more rudimentary and above the ground fashion). see FIGS. 25-26. Thus, the web-like netting structure can (if desired) easily covering relatively large designated areas of the backyard or terrace or roof of the dronespot. On the other-hand, the net can be collapsed or rolled up when some or all of the designated space is needed for other purposes.

The net can be erected horizontally, vertically, conically or at an angle with the best embodiment being that of the cone as well as that of an adjustable angle so as to allow for the parcels to roll/slide off it towards the desired collection point (think of it like having an A4 sheet of paper squeezed in a parabolic curve thus creating a half-funnel—pretty much like a tilted taco [with the sauce dripping]), or a lean-to structure beside a building.

Identification of the area of the net can take place through, for example, image processing of appropriate machine-readable signs on the net (like the machine-readable signs that exist on a QR code). These signs can be printed by the dronespot owner/handler and placed on appropriate points (e.g. the corners) of the net. By utilizing information from a camera (e.g., AR input data) of the drone we can compute the drop off area on the spot so as to compensate for any discrepancies on rolling out the net as well as for different net sizes and shapes.

### OVERVIEW DRAWINGS

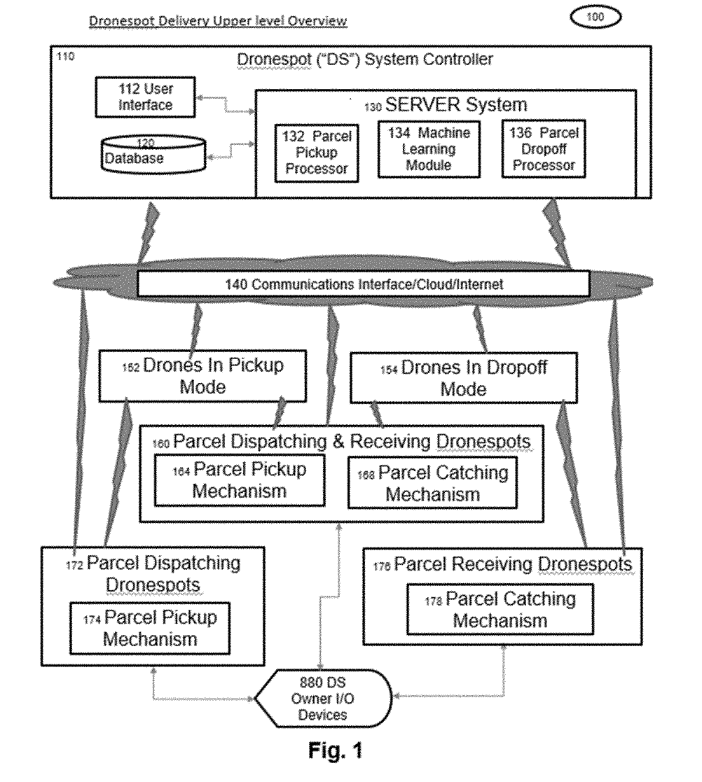

FIG. 1 is a block diagram illustrating an upper level overview of an embodiment of our dronespot delivery system (100). Element 110 illustrates exemplary components of our DSC or system Controller. These include: user I/O (112), database (120) & server (130) subsystems. Element 140 illustrates electronic communications linkages through interface elements with cloud, internet, telephony and/or other telecommunications networks.

Drones in Pickup mode (152) and Dropoff mode (154), respectively are shown communicatively coupled to different types of dronespots (“DS”). Our system encompasses one subset of DS (160) which are adapted for both airborne parcel pickup & delivery, and these DS are equipped with both parcel pickup mechanisms (164) and parcel catching mechanisms (168). Another subset of DS may be adapted for airborne parcel pick (174), but not airborne delivery. Still another subset of DS (176) may be adapted for catching (178) dropped parcels but not for dispatching parcels to hovering drones.

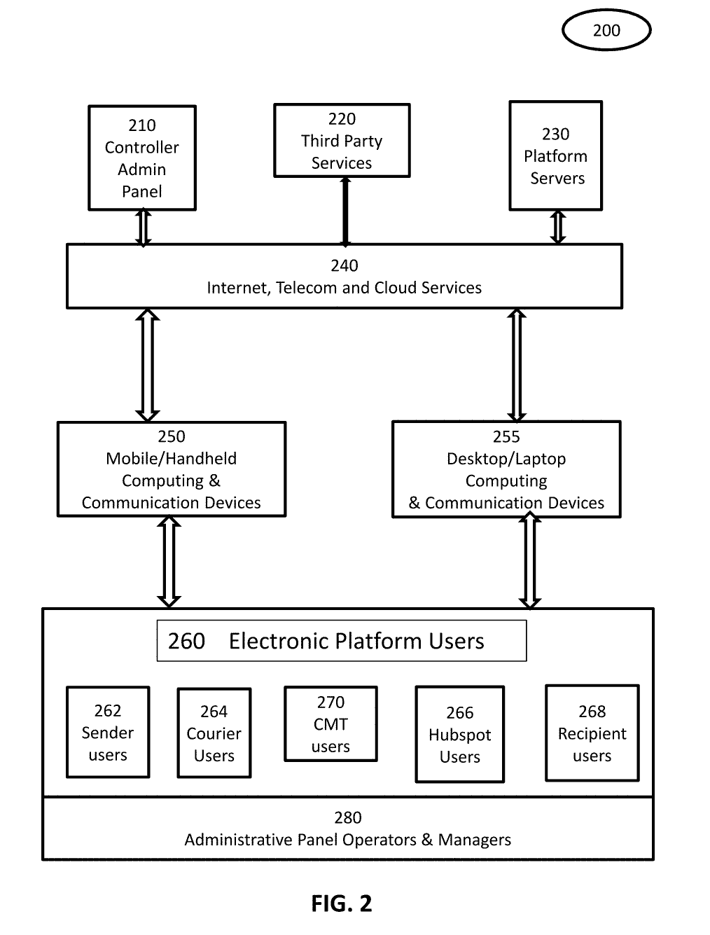

FIG. 2 is an overview block diagram of an electronic logistics platform, for a package handling service, which might be used in conjunction with the disclosed drone delivery system. For more details regarding this type of logistics ePlatform, see commonly owned Afordakas '722 application.

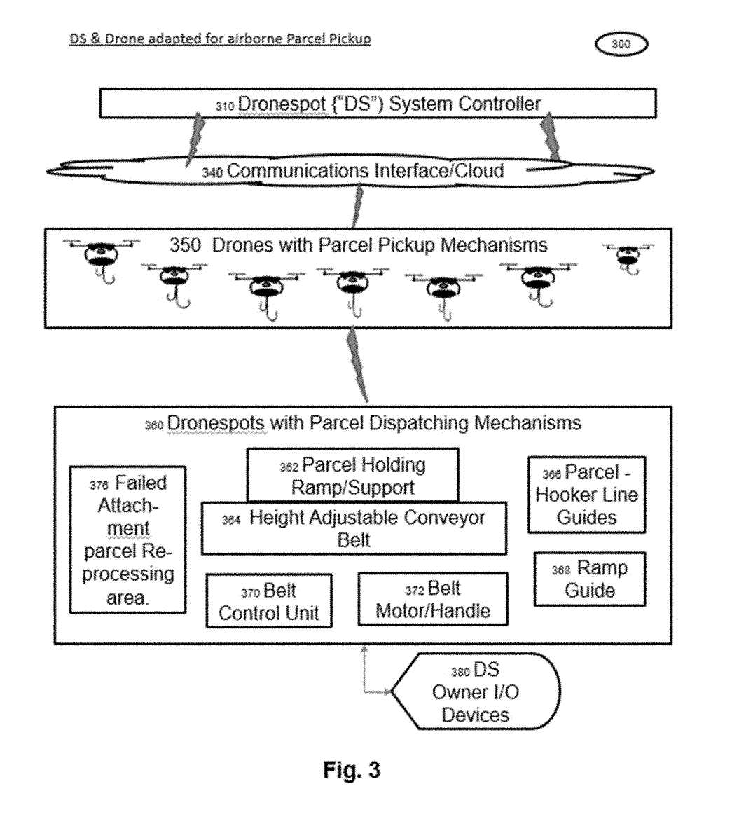

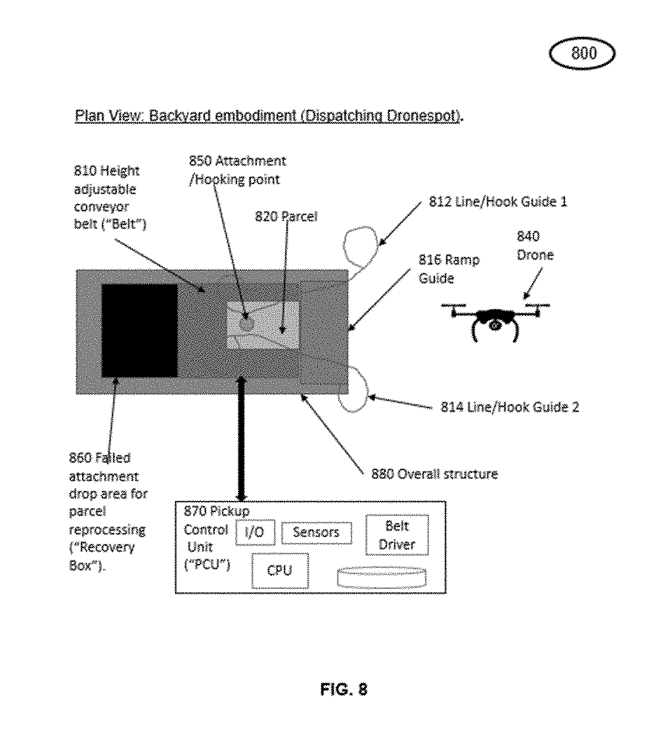

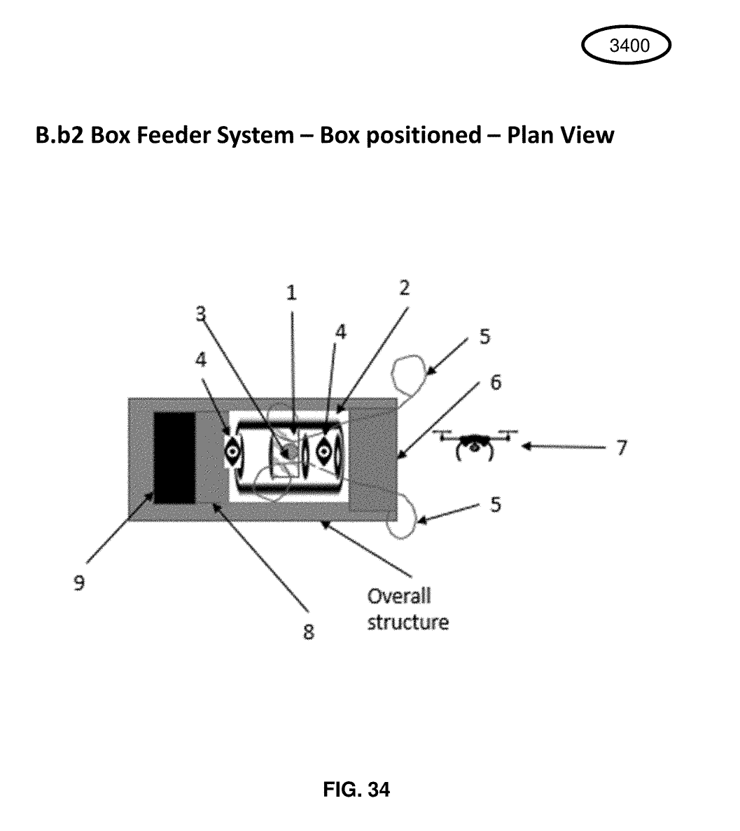

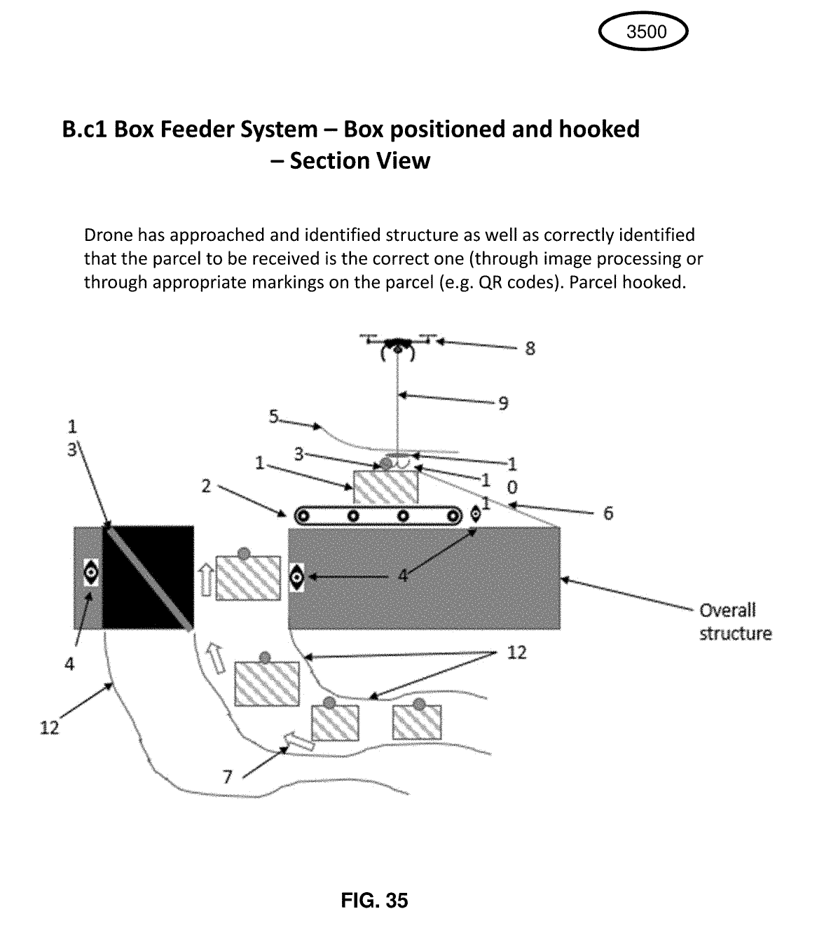

FIG. 3 is a block diagram illustrating an exemplary DS and drone adapted for airborne parcel pickup (300). This means that the system is configured for a hovering drone (350) to contact and pickup a parcel from a DS (360) on the ground without the drone having to land. DS devices and apparatuses facilitating this process include: a parcel holding ramp/support (362) and a height adjustable (e.g., see element 2 on FIG. 35) conveyor belt (364); parcel-hooker line guides (366) and ramp guides (368); a belt motor/mover, which may be controlled by hand (372) or by an electro-mechanical belt control unit (370); and a failed attachment parcel re-processing area (e.g., see element 9 on FIG. 34). This can be used to collect (e.g., see feeder separator element 8 on FIG. 34 et al) and re-position the package for another try if for some reason a prior pickup attempt was not successful. See also FIG. 8.

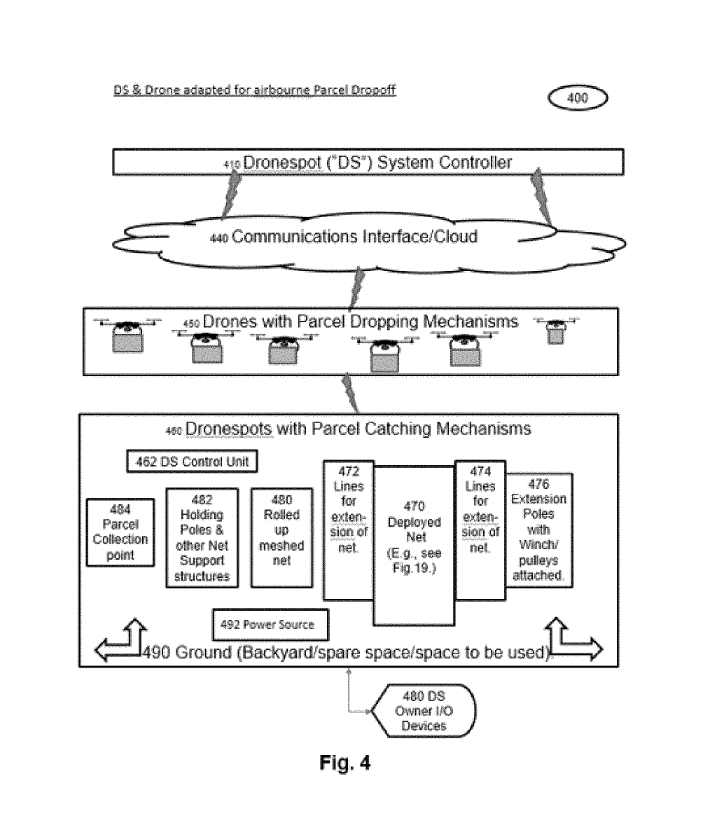

FIG. 4 is a block diagram illustrating an exemplary DS and drone system adapted for airborne parcel dropoff (400). This means that the system is configured for a hovering drone (450) to release a parcel for delivery to, and receipt by, a DS (460) on the ground, without the drone having to land. DS devices and apparatuses facilitating this process include: a DS Control Unit (462); mesh type net structures, which may (at a given time) be either rolled-up (480) or deployed (470); lines (472, 474) for extension of one end of the net toward extension poles (476) which may have winch/pulleys attached; holding poles and other net support structures (482) attached to a second or fixed end of the net. (see FIG. 19.) The second end of the net may also be affixed to a building/wall or other structure. (see FIG. 21.) The embodiment of our invention shown on FIG. 4 also includes a power source (492) and one or more parcel collection points (484). (see FIG. 25 or FIG. 27.)

### Logic Flowcharts & Dronespot Drawings

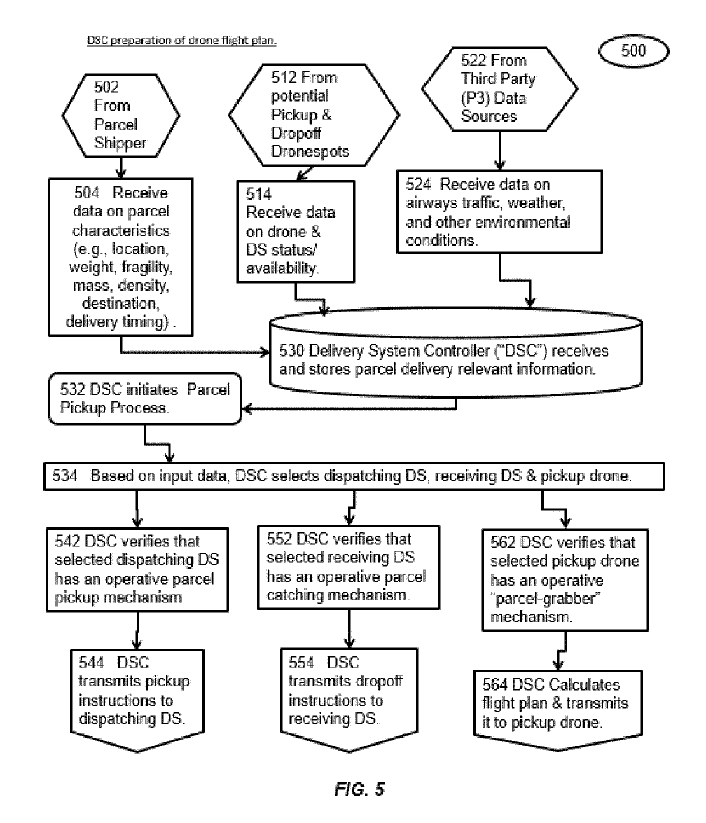

FIG. 5 is a flowchart illustrating an embodiment of our invention showing Delivery-Sysytem-Controller (“DSC”) logical operations used to prepare flight plans for drones used to pickup packages from a dronespot (500). At step 504, the DSC 504 receives input information from a parcel shipper (502). Such input includes: data on parcel characteristics (e.g., location, weight, fragility, mass, density, destination, delivery timing). At step 514, the DSC receive data, on drone availability & DS status/availability, (512) from potential Pickup & Dropoff dronespots. At step 524, the DSC receives data—such as airways traffic, weather, and other environmental conditions, from a plurality of third Party (P3) Data Sources (522). After the DSC receives and stores relevant parcel delivery information (530), DSC initiates a parcel Pickup Process (532).

Based on input data, DSC selects dispatching DS, receiving DS & (one or more) pickup drones (534). After it verifies (542) DSC verifies that a selected dispatching DS has an operative parcel pickup mechanism, the DSC transmits pickup instructions to the selected dispatching DS (544). After (552) DSC verifies that selected receiving DS has an operative parcel catching mechanism, DSC transmits dropoff instructions to receiving DS (554). After (562) DSC verifies that selected pickup drone has an operative “parcel-grabber” mechanism, DSC Calculates flight plan & transmits it to pickup drone (564).

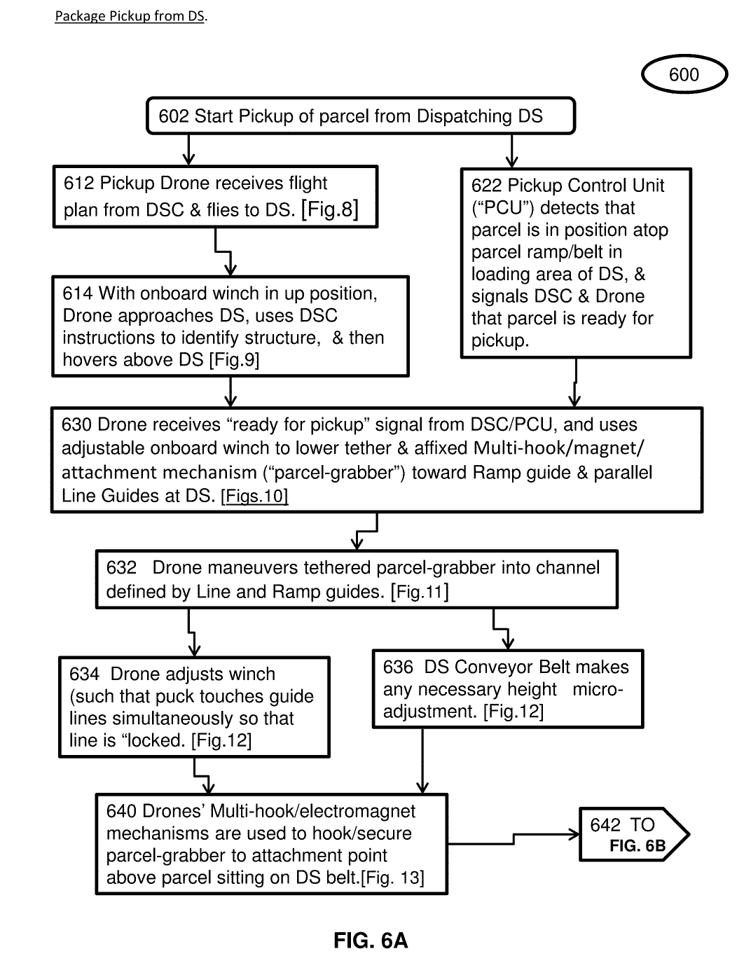

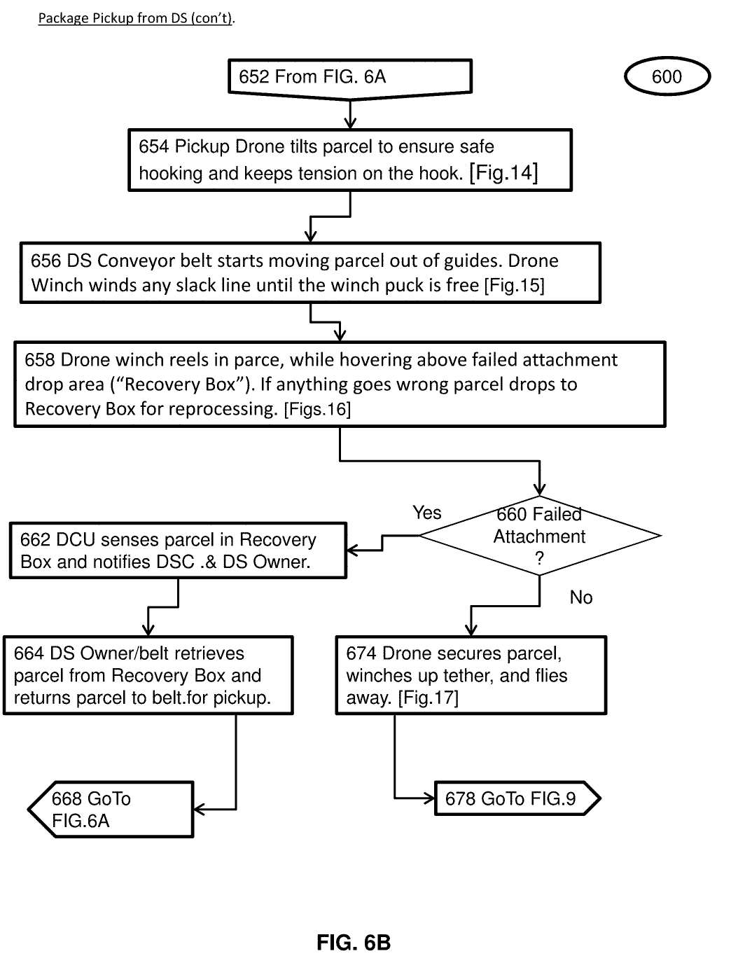

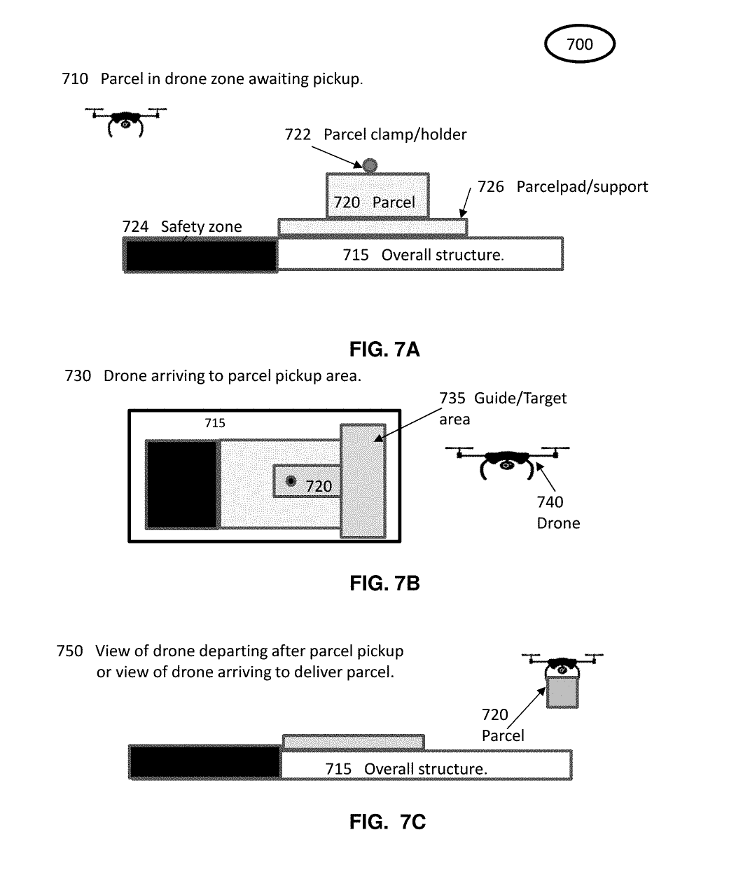

FIGS. 6A and 6B are flowcharts which illustrate logic flow for drone and dronespot interaction for one embodiment of our invention, during the parcel pickup process (600). On FIG. 6A, after procedure for pickup of parcel from dispatching DS starts at step 602, Pickup Drone receives flight plan from DSC and flies (612) to dispatching DS with an onboard winch in up position. [see FIG. 7A.] Drone approaches DS (614), uses DSC instructions to identify structure, & then hovers above/near DS [see element 840 at FIG. 8.]

On the ground, the dispatching DS is configured with a digital Pickup Control Unit (“PCU”). This PCU (see element 870 at FIG. 8) is programmed and configured with CPU, memory and other computer elements for receiving and transmitting logical and control instructions among the drone, dispatching DS, and the DSC (delivery-system-controller). At step 622, the PCU detects (e.g., see scanner eye element 4 on FIG. 35 et al) that parcel is in position atop parcel ramp/belt in loading area of DS, & signals DSC & Drone that parcel is ready for pickup. Drone also identifies if that the parcel to be received is the correct one (e.g., through image processing, or through appropriate markings on the parcel (e.g. QR codes) or belt. (E.g., FIG. 35)

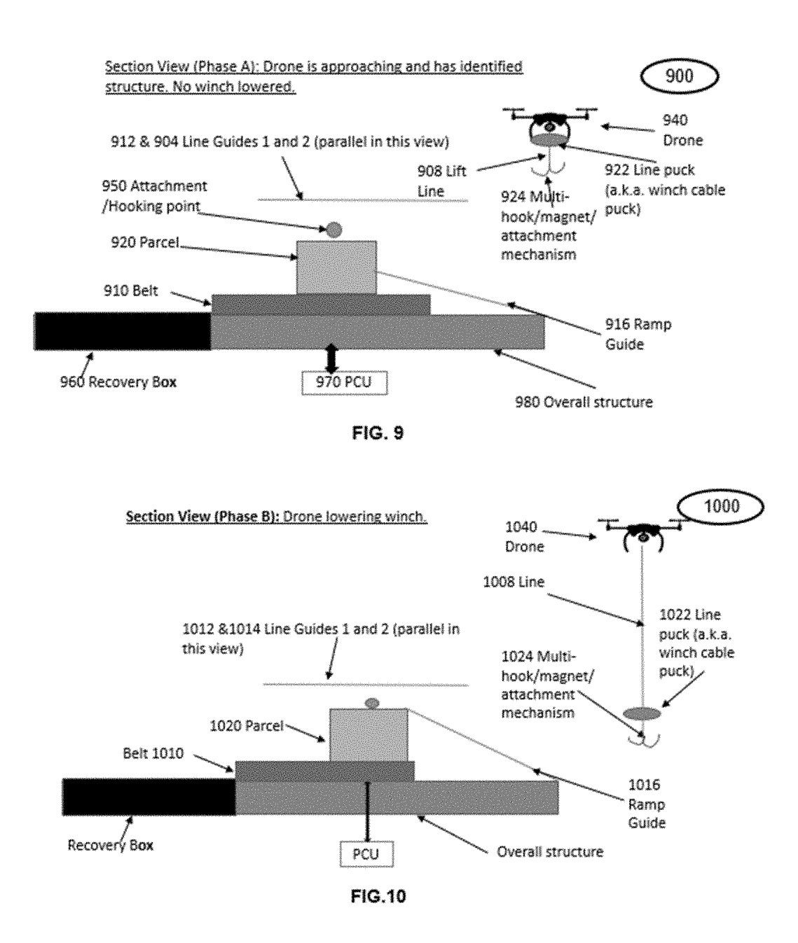

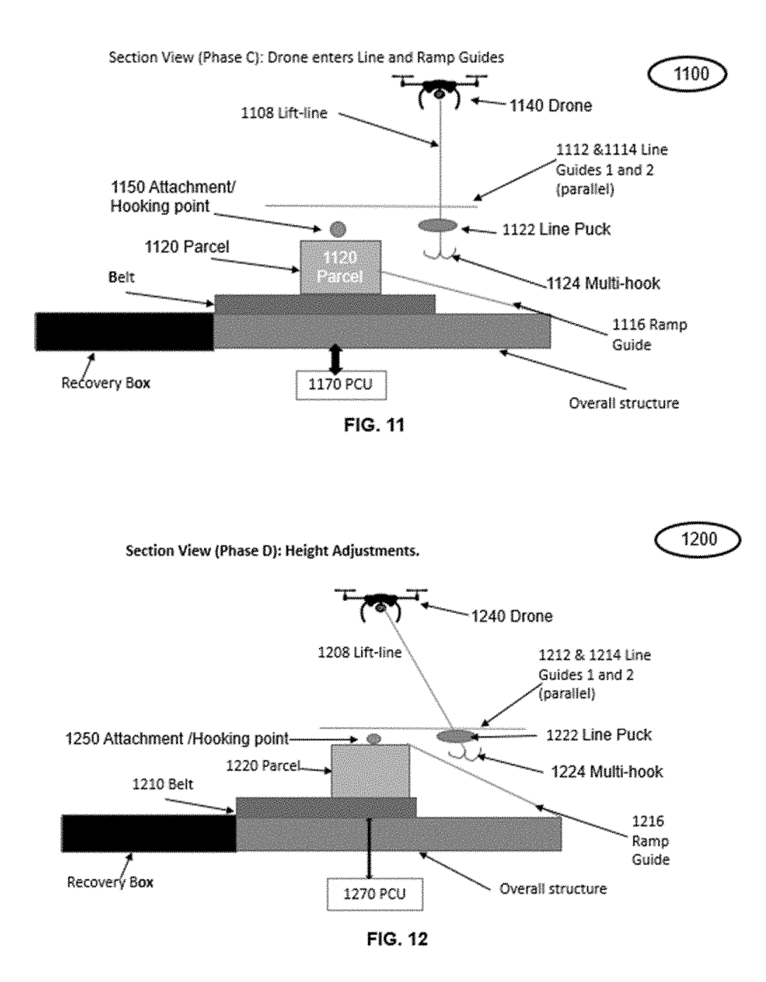

Next (630) Drone receives “ready for pickup” signal from DSC and/or PCU, and uses an adjustable onboard winch to lower tether & affixed Multi-hook/magnet/attachment mechanism (“parcel-grabber”) toward Ramp guide & parallel Line Guides at DS. [FIGS. 9-10] Then (632) drone maneuvers tethered parcel-grabber into channel defined by Line and Ramp guides. [FIG. 11] Drone then (634) adjusts winch (such that puck touches guide lines simultaneously) so that line is “locked”. [FIG. 12]

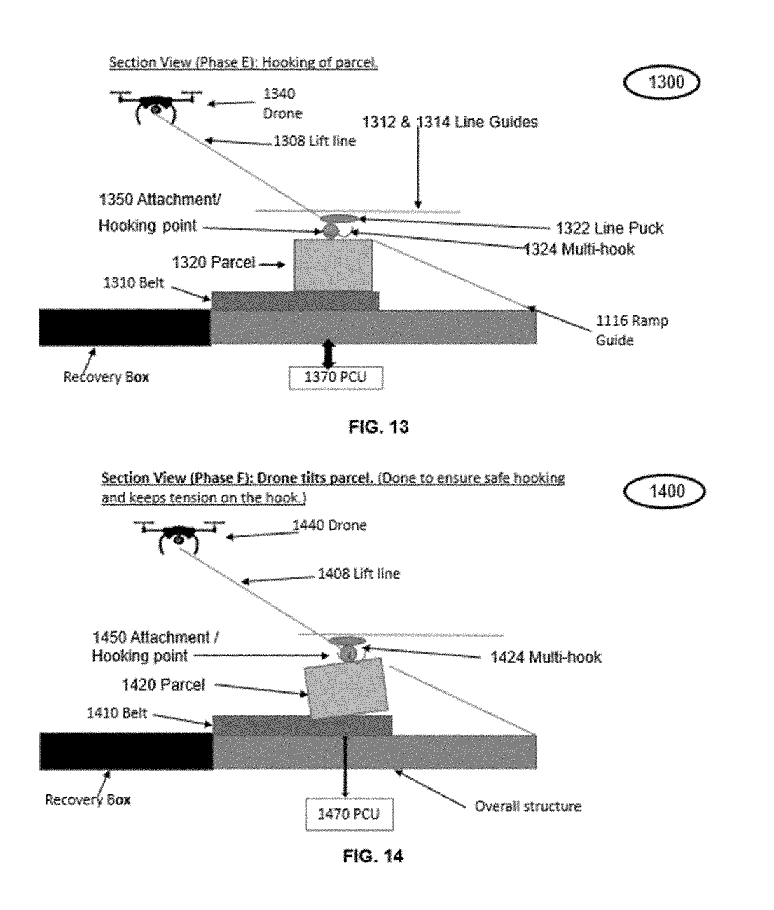

During this “locking” maneuver, DSC/PCU instruct the DS Conveyor Belt to make any necessary height micro-adjustment. [FIG. 12] At step 640), the drone's Multi-hook/electromagnet mechanisms (see element 924, FIG. 9) are then used to hook/secure parcel-grabber to attachment point (see element 950, FIG. 9) above parcel sitting on DS belt. [FIG. 13]. Airborne Package Pickup Process (from DS), then goes to element 642 at FIG. 6B.

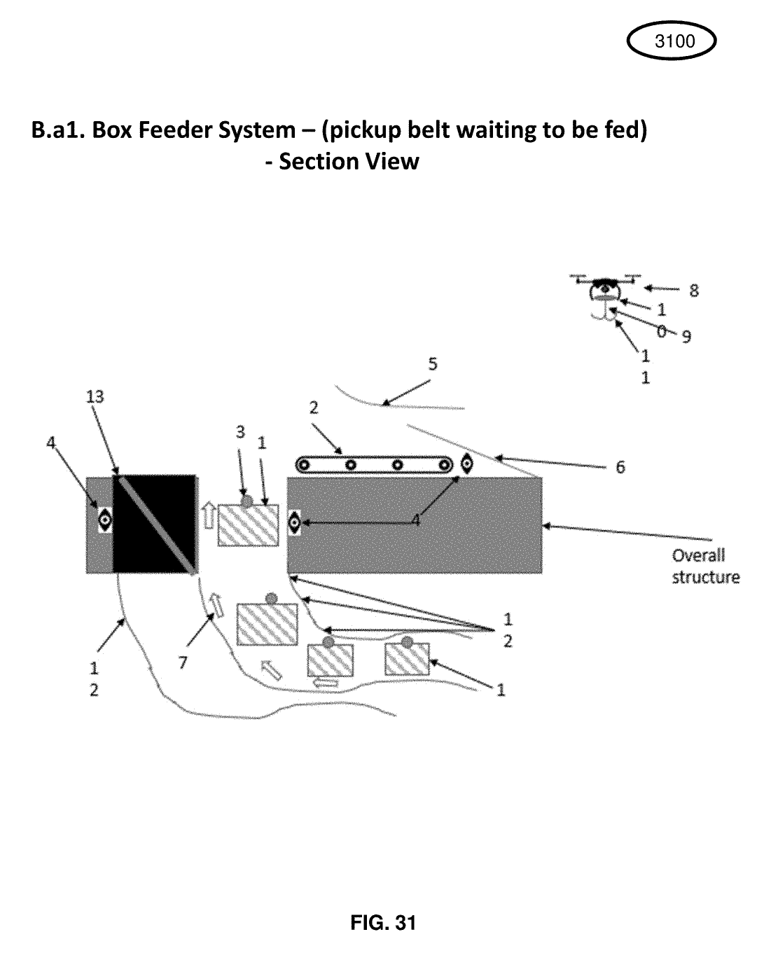

As illustrated on FIG. 6B, during airborne pickup procedure, the pickup drone (654) tilts parcel to ensure safe hooking and keeps tension on the hook. [FIG. 14] Next (656) DS Conveyor belt starts moving (e.g., see direction-of-movement icons 7 on FIG. 31 et al) parcel out of guides.

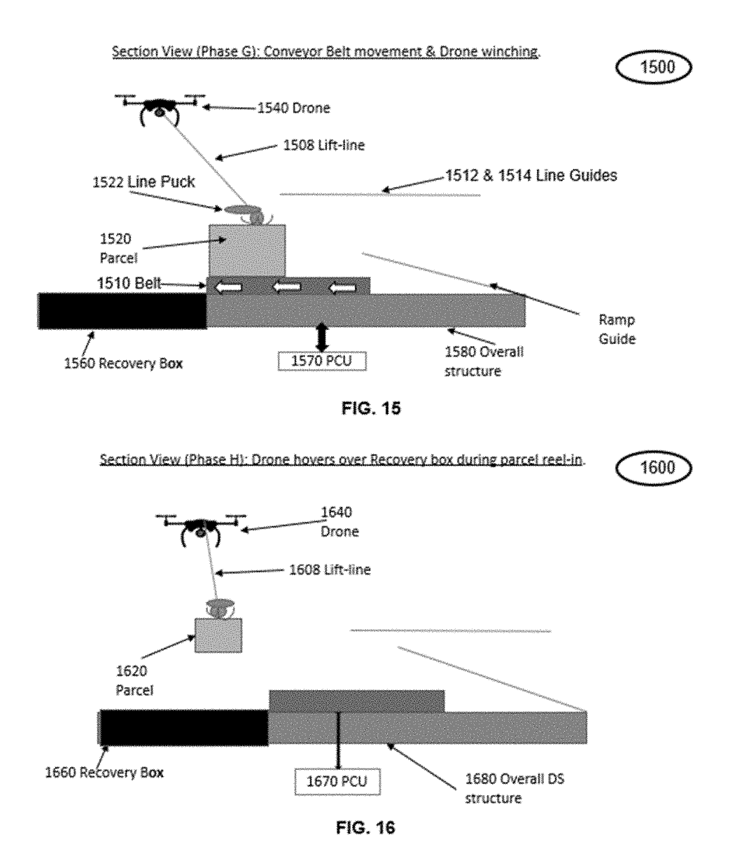

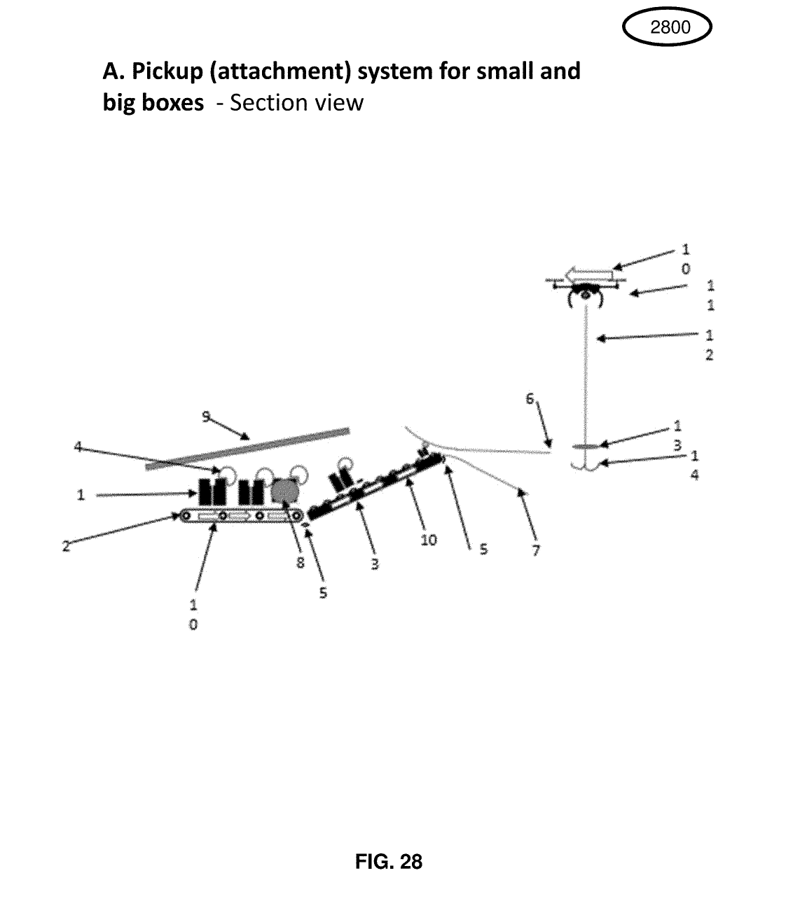

During parcel movement, scanner eyes detect the parcel position (e.g., see element 4 on FIG. 31 et al) Drone Winch winds any slack line until the winch puck is free [FIG. 15] Note that, as used herein, a POSITA (“person ordinarily skilled in the art”) would recognize that the terms “conveyor belt” or “belt” refer to a mechanical assembly which conventionally can include different types of belt “driver” mechanism; and that such a driver might typically comprise an electric motor and/or a hand-crank or other motive means. Such belt mechanism might also include: some belts that are stubbed (e.g., see element 3 on FIG. 28), some belts that are stubbed or normal (e.g., see element 2 on FIG. 28), and some belts that are height adjustable (e.g., see element 2 on FIG. 31)

Next, at step 658, drone uses its winch to reel in parcel, while hovering above failed attachment (e.g., see element 9 on FIG. 34) drop area (“Recovery Box”). If anything goes wrong, during the hooking & reeling steps, then the parcel drops to the Recovery Box for reprocessing. [FIGS. 16] At step 660, system determines whether the attachment attempt succeeded or failed. If it failed (662), PCU sensors & logic verify that parcel is in the Recovery Box and so notifies DSC & DS Owner.

Then (664), DS Owner/belt retrieves parcel from Recovery Box and returns parcel to belt to re-initiate the pickup procedure (668). By “Owner/belt we mean that a DS human (Owner/operator/staffer/employee etc.) could pickup the parcel from the box and reposition parcel (for contemporaneous or later) pickup by the same or a different drone (e.g., a drone with capacity to hold/carry heavier parcels). Alternatively, the recovery box could be part of the belt itself, or the belt/box could be configured in a continuous loop fashion.

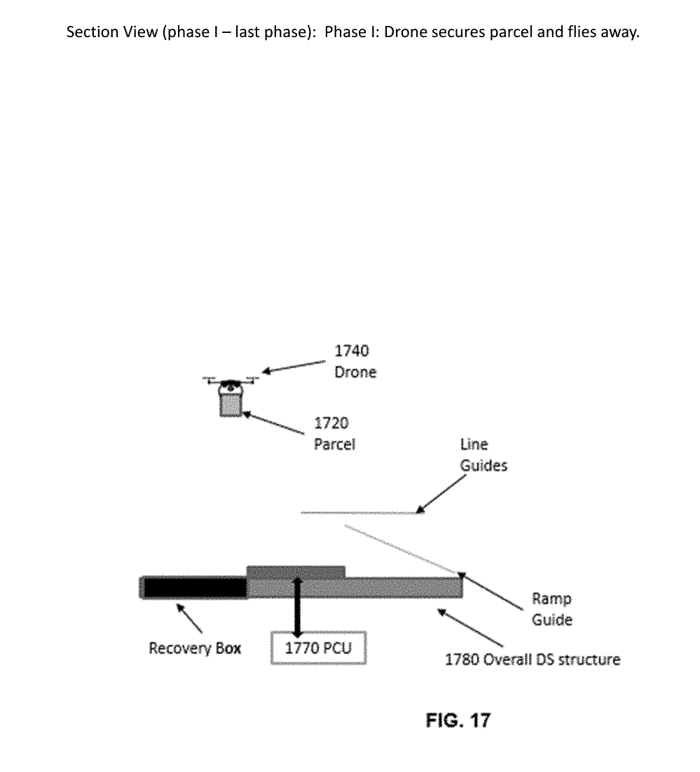

On the other hand, when an attachment try is successful (660), the pickup (674) drone secures parcel, winches up tether, and flies away. [see element 1720 at FIG. 17.]

FIGS. 7A, 7B & 7C are comparison illustrations of a parcel holding pad/drone landing structure which does NOT have mechanisms for automated airborne parcel pickup (700). Such a location could, however, be one from which a parcel was loaded onto a drone (e.g., by hand) for later delivery using airborne dropoff embodiments of our invention.

FIG. 8 shows an overhead Plan View a Backyard embodiment, of a dispatching dronespot, which does have mechanisms for facilitating automated parcel pickup (800). This dispatching DS includes our inventive parcel holding structure (880). It further includes a height adjustable conveyor belt (810), under a parcel (820) with an attachment/hooking point (850); a “Failed attachment” drop area or “Recovery Box” (860) for parcel reprocessing; and a Pickup Control Unit or “PCU”. The PCU (870) includes functional computer components (or equivalents) such as a suitably programmed CPU, memory, sensors, I/O, and logic means for controlling movement of the conveyor belt (i.e., a belt driver). This embodiment also includes line/hook elements (812, 814) for guiding pickup drones (840) into proper pickup position above the structure (880)

FIG. 9 shows a section view [Phase A] of an embodiment of a dispatching DS and pickup drone, with automated mechanisms for engaging and lifting up a parcel from the DS, while the pickup drone remains airborne (900). In addition to the details shown in FIG. 8, the FIG. 9 embodiment includes: a multi-hook/magnet/attachment mechanism (924); a line puck—a.k.a. winch cable puck (922); a Ramp guide (916); and a flexible winchable Lift-line/cable. This Lift-line is affixed to a winch assembly on the drone (940), and it is used to lower the hook (924), from the body of the pickup drone, to the (950) Attachment/Hooking point on top of the parcel (920) on the belt (awaiting pickup).

FIG. 10 shows a section view [Phase B] of an embodiment with pickup drone's winch tether/Lift line & parcel attachment mechanism being lowered toward the parcel dispatching DS structure (1000). Also note that in both the FIG. 9 and FIG. 10 views, Line Guides 1 & 2 (e.g., elements 1012 & 1014) are parallel, and thus only one Guide line is shown in these views. Also, comparison of the relative positions of the Ramp Guide in FIG. 9 (916) and FIG. 10 (1016), indicates how these elements are used to steer the pickup drone (1040) into proper position above the awaiting parcel (1020).

FIG. 11 shows a section view [Phase C] of an embodiment with a drone entering the Line and Ramp guides (1100). The drone (1140) is being maneuvered to get its parcel-grabber elements into position for pickup. Here the Lift-line (1108) and hookup mechanisms (1122, 1124, 1150) are being steered toward the Attachment point (1150) using the line guides (1112, 1114) and ramp guide (1116).

FIG. 12 shows a section view [Phase D] of an embodiment illustrating height adjustments of the winch and belt mechanisms (1200). To facilitate engagement of the multi-hook (1224) and Attachment point (1250), the drone (1240) can adjust the winch height (e.g., by reeling/unreeling the Lift-line); and the PCU (1270) can make height adjustments of the conveyor belt at the dispatching DS. Here, during the winch adjustment, the puck touches both guide lines simultaneously so that line is “locked”); and any height micro-adjustments are performed by Belt (if necessary) responsive to commands from PCU (1270) and/or DSC.

FIG. 13 shows a section view [Phase E] of an embodiment illustrating hooking of a parcel at a dispatching DS (1300). Here, while suspended from the pickup drone (1340) by the Lift-line (1308), the parcel-grabber/Attachment mechanism (1322,1324) is engaging the Attachment/Hooking point (1350) atop a parcel (1320) sitting on the DS belt (1310). For example, in some embodiments, the attachment mechanism can be a 3 or 4-way hook (similar to “fake-bait” fishing hooks), which has a safety pin for not unhooking if not in tension. Alternatively, in some embodiments, the attachment mechanism can be an electromagnetic assembly.

FIG. 14 shows a section view [Phase F] of an embodiment (1400) illustrating the drone (1440) tilting the parcel (1420). After the drone's attachment mechanism (1424) makes contact with the Attachment/hooking point atop the parcel (1450); the drone exerts tension on its Lift-line (1408), and maneuvers itself so as to tilt the parcel (1420) while the parcel is still in contact with the DS' belt (1410). This procedure is executed to ensure safe hooking and keeping tension on the hook, when the parcel is subsequently lifted from the belt (1410).

FIG. 15 [Sheet 13] shows a section view [Phase G] of an embodiment illustrating DS conveyor belt movement in coordination drone winching (1500). Conveyor belt (1510) starts moving parcel (1520) out of Line guides (1512,1514). Concurrently, drone (1540) winch winds any slack line (1508) until winch/line puck (1522) is free.

FIG. 16 shows a section view [Phase H] of an embodiment illustrating a drone reeling in a parcel (1600). Here, the drone hovers over the Failed attachment area/Recovery Box (1660) during the reel-in. This is done so that the parcel could drop into the recovery box, if anything goes wrong while the drone winches up and reels in the parcel (1620) that it has lifted from the DS.

FIG. 17 shows a section view [Phase I—last phase] of an embodiment (1700). It illustrates a drone (1740) that has secured its parcel (1720) and is flying away from dispatching DS (1780).

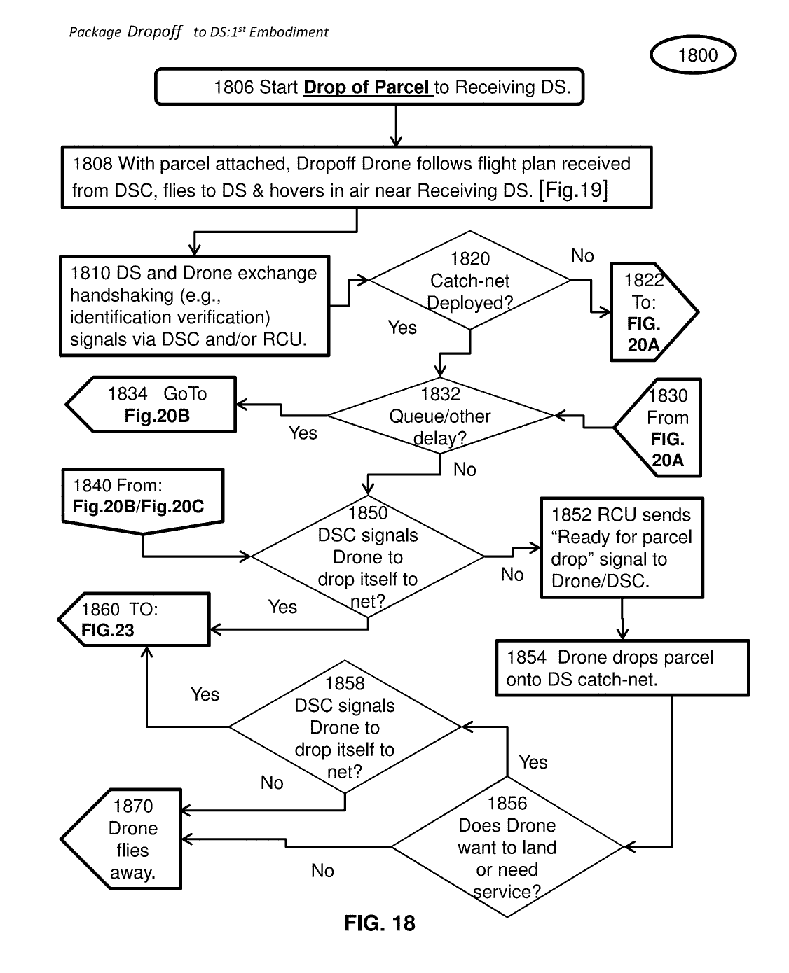

FIG. 18 is a flowchart illustrating logic flow for an embodiment where a drone drops off a parcel at a dronespot without landing, and/or the drone drops itself onto a DS catch-net for servicing (1800). Process logic, for airborne drop of parcel to a Receiving DS, starts at step 1806 At step 1808, with parcel attached, Dropoff Drone follows flight plan received from DSC, flies to DS & hovers in air near/above Receiving DS. [See FIG. 19.]

The receiving DS and dropoff drone exchange handshaking (e.g., identification verification) signals via DSC and/or RCU (1810). Note that (similar to the “PCU” computer means at the Pickup/dispatching DS sites) the Receiving DS sites are configured with Receiving Control Units (“RCU”) with logic/memory/peripheral elements adapted to control & facilitate parcel dropoff operations. Note also that some/all of the RCU logic functions can be programmed to be performed as part of centralized controllers/servers (such as the DSC (Delivery-System-Controller), as part of local or standalone units, in processor means combining botb PCU and RCU functions, etc.

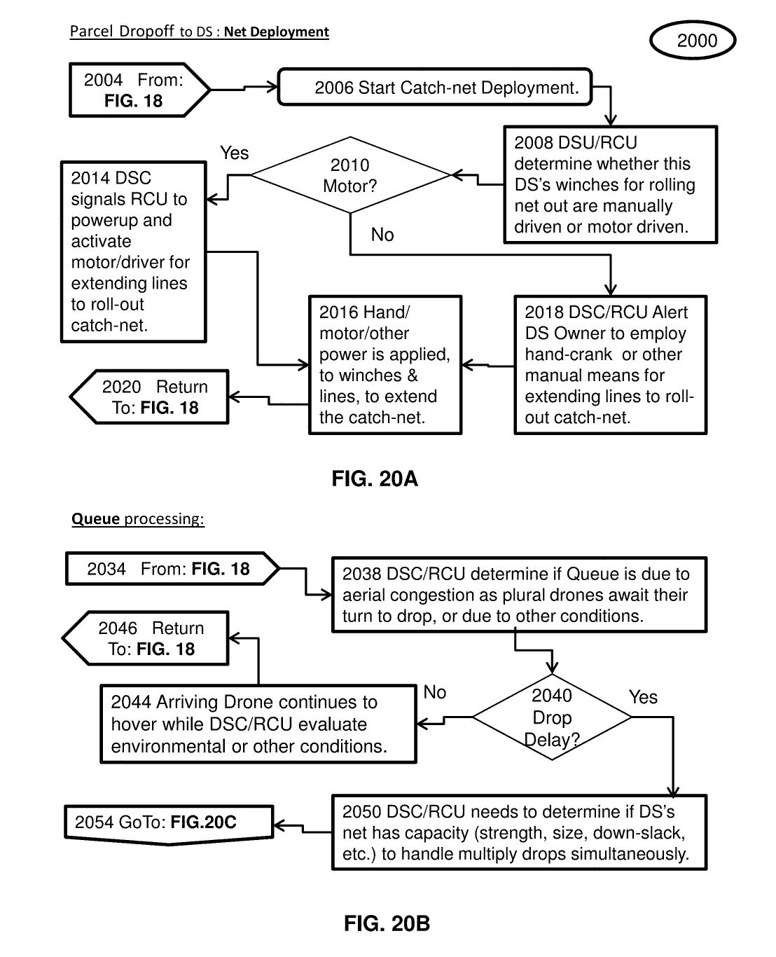

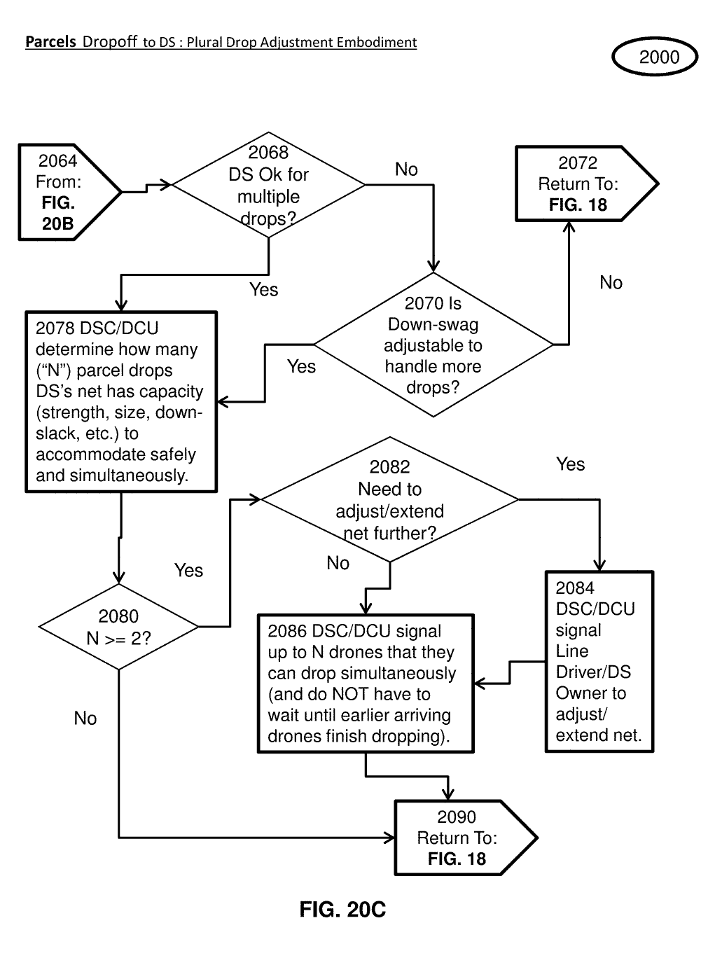

Next, it is determined whether a Catch-net has been deployed (1820), at the Receiving DS; and If not (1822), process goes to FIG. 20A. If a net has been extended, it is determined if there is a queue of drones (e.g., waiting to drop parcels) or if there is some other delay (e.g., weather, congestion). If so (1834), process goes to FIG. 20B. Based in part on input from FIGS. 20B/20C, at step 1850, it is determined if the DSC should signal the hovering drone to drop itself onto the net. If answer is yes (1860), process goes to FIG. 23.

If the answer is no (1850), then RCU sends “Ready for parcel drop” signal to Drone/DSC (1852); and the releasing drone drops parcel onto receiving DS catch-net (1854). Next, it is determined if the releasing drone wants to land or needs service (1856). If not, the releasing drone flies away (1870). If answer (1856) is yes, process goes to step 1858 again. There, if DSC signals drone to drop itself to net, process again goes to FIG. 23 (1860). If DSC does not signal it to drop itself onto this DS' catch-net, the drone flies away.

FIG. 19 shows an overhead view (1900) of a 1st Backyard (1904,1906) embodiment of a dronespot with a Rolled-up mesh net (1930) and a single point (1910) for collecting dropped parcels. The shown embodiment is next to a building (1908) and includes: poles (1930,1932,1934) for holding a fixed end (building side) of the net; Draw-lines (1920,1922,1934) for drawing out/extending the net toward away-poles (1950,1952,1954); and winches/pulleys (1960,1962,1964) for pulling the draw-lines; a power source for driving the winches/pulleys; and a RCU (1970) which can be used to control certain DS operations, such as activating winches.

FIG. 20A is a flowchart illustrating catch-net deployment for parcel drop-off at a receiving dronespot (2000). After a signal (from FIG. 18) that the parcel catching net is not out, net deployment starts (2006). DSU/RCU determine whether this DS's winches for rolling net out are manually driven or motor driven (2008). If motor driven (2010), DSC signals RCU to powerup and activate motor/driver for extending lines to roll-out catch-net (2014). Process then goes to step 2016.

If line-extending means is not motor driven (2010), then 2018 DSC/RCU alert DS Owner to employ hand-crank or other manual/non-motor means for extending lines to roll-out catch-net (2018). Next, at step 2016, hand/or electro-mechanical/other power is applied, to winches & lines to extend the catch-net under a drop zone. Process then returns to FIG. 18 (2020).

FIG. 20B is a flowchart illustrating queue handling procedures when a plurality of drones are hovering in/near the receiving DS drop zone awaiting processing. After notice that there is a queue of drones waiting (FIG. 18), DSC/RCU determine if queue is due to drop delay/aerial congestion (i.e., because plural drones are awaiting their turn to drop their parcels), or due to environmental or other conditions (2038). If not due to drop delay (2040), arriving drone continues to hover while DSC/RCU evaluate environmental or other conditions (2044). If queue is due to drop delay (2040), then DSC/RCU needs to determine if DS's net has capacity (strength, size, down-slack, etc.) to handle multiply drops simultaneously (2050). Process then goes to FIG. 20C (2054).

FIG. 20C is a flowchart illustrating embodiments with adaptations for receiving dronespots which are capable of handling plural parcel drops from plural drones during the same time period. At step 2068, it is determinated whether the instant receiving DS is operationally ready for multiple drops. If not, it is determined if catch-net down-swag (at this DS) is adjustable to handle more drops (2070); and if not, process returns to FIG. 18 (2072).

If down-swag is so adjustable, DSC/DCU determine how many (“N”) parcel drops receiving DS's net has capacity (strength, size, down-slack, etc.) to accommodate safely and simultaneously (2078). If N is only one, process goes to step 2090. If N is two or more, then it is determined if net needs to be adjusted/extended further (2082). If answer is yes, DSC/DCU signal Line Driver/DS Owner to adjust/extend net accordingly (2084). Next, DSC/DCU signal up to N drones that they can drop simultaneously, and do NOT have to wait until earlier arriving drones finish dropping (2086). Process then returns to FIG. 18 (2090).

FIG. 21 shows a view, from above, of a 1st Backyard embodiment of a dronespot with a Rolled-out net and a single collection point (2100). Here, the DS' catch-net is configured for receiving a plurality of parcels (2120) dropped from a plurality of drones (2140).

FIG. 22 shows a view, from the side, of a 1st Backyard embodiment of a dronespot with a Rolled-out net and a single collection point (2200). Here, element 2202 shows an allowed aerial dropoff zone, when the DS' Draw-lines (2272) have been used to extend a rolled-up mesh net (2230) to away poles (2250). Winches (2262) attached to these poles (2250) are used to pull the Draw-lines to these poles. The winches can be manually cranked or be electromechanically powered (2212). Element 2222 illustrates plural parcels sliding down a slacked net (2234) toward a collection point (2210).

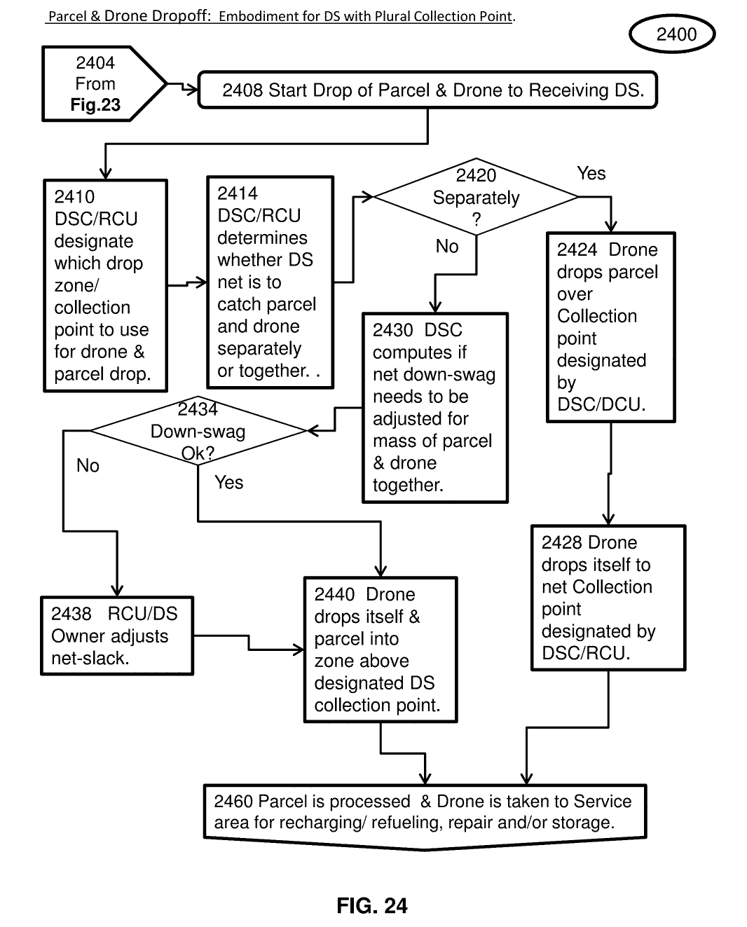

FIG. 23 [is a flowchart illustrating an exemplary embodiment where adjustments are made to facilitate dropping both the drone and parcel at a receiving dronespot with a single collection point (2300). After DSC signals drop-off drone to drop itself onto catch-net (FIG. 18), process for drop of parcel & drone to receiving DS starts at step 2304. DSC determines if receiving DS net is configured with a single (FIGS. 19,21,22) or plural (FIGS. 25, 27) Collection points (2308). If plural collection points (2010), process goes to FIG. 24 (2314).

If single collection point (2010), DSC determines whether DS net is to catch parcel and drone separately or together (2320). If separately (2330), drone drops parcel onto DS catch-net (2334); hovers above DS until parcel is collected from net (2338); then drone drops itself onto net (2340), and process goes to step 2360. If parcel & drone are to be dropped together, DSC computes whether catch-net down-swag needs to be adjusted for mass of parcel & drone together (2340). If down-swag is already okay (2344), process goes to step 2350. If down-swag is not okay (2344), DCU/DS Owner adjusts net-slack appropriately (2348). In other words, in some embodiments (e.g., at some receiving DS) the down-swag adjustments may be done manually. In other embodiments, DSC server logic generates signals to actuate electro-mechanically line driver means (to adjust down-swag as needed). Then, at step 2350, delivery drone drops itself & parcel onto DS catch-net.

Next, parcel is removed from net for further processing, and drone is taken to a service area (2360). Such further parcel processing may include preparation/storage of package for additional conveyance along another delivery leg (e.g., by courier, ground vehicle, another drone, etc.). Such drone servicing can include: recharging/refueling, repair/maintenance and/or storage (e.g., until weather improves, repair tools arrive, another parcel needs dispatching, etc.).

FIG. 24 is a flowchart illustrating an exemplary embodiment with adaptions for both parcel and drone drop-offs at a receiving dronespot with plural collection points (2400). Based on input (2404) from FIG. 23, procedure starts at step 2408. Then, DSC/RCU designate which drop zone/collection point is to be used for drone & parcel drop (2410). Next, DSC/RCU determine whether DS net is to catch parcel and drone separately or together (2414). If separately (2420), delivery drone drops parcel over Collection point designated by DSC/DCU (2424); drone drops itself to net Collection point designated by DSC/RCU (2428); and process proceeds to step 2460.

If parcel & drone are to be dropped together (2420), DSC computes whether net down-swag needs to be adjusted for mass of parcel & drone together (2430). If (2434) down-swag is already okay, process goes to step 2440. If down-swag is not okay, RCU/DS Owner adjusts net-slack as needed (2438); and process goes to step 2440. There, the delivery drone drops itself & parcel into aerial zone above designated DS. Then, parcel is processed & drone is taken to Service area for recharging/refueling, repair and/or storage (2460). This post-drop parcel processing and drone servicing is comparable to that discussed above (regarding step 2360).

FIG. 25 another view from above of a 2nd Backyard embodiment illustrating a dronespot with plural points for collecting dropped parcels (2500). Here, the DS is next to a building (2508), which has wall mounted hooks (2542,2544,2546). These hooks replace some the poles (i.e., those at the fixed end of the net) for attachment to a rolled up meshed net (2530). Draw-lines (2572,2574,2576) are used to extend the net from the building (2508) wall to a first set of poles (2562,2564,2566), and/one or more additional sets of poles (2582,2584,2586). Thus, a DS can be configured for twin or multiple collection points (2512,2514).

FIG. 26 illustrates an embodiment of a 2nd Backyard embodiment showing plural drones over a dronespot with plural collections points (2600); and with fixed end poles replaced by wall mounted hooks (2642,2644,2646).

FIG. 27 illustrates a view (2700) from the side of a 2nd Backyard (2704,2708) embodiment of a dronespot with plural collections points Here, the catch-net (2734) is rolled-out, using winches (2768) affixed to wall mounted hooks (2742). The net is rolled to away winches (2762,2782) attached to two or more sets of vertical poles (2762,2792). This is used, when the net is deployed, to create a plurality of Allowed dropoff aerial zones (2702,2704), into which plural parcels (2722) can be dropped by plural drones (2740). Dropped parcels can then slide down slacked net (2734) into plural collection receptacles (2712,2714).

FIG. 28 illustrates a Section view [A.] illustrating an embodiment with a Parcel Pickup (attachment) system for small and big boxes (2800). This view includes: 1. Box with gills, 2. Conveyor belt (stubbed or normal), 3. Conveyor belt (stubbed), 4. Attachment loop, 5. Scanner eye for knowing parcel position, 6. Line/Hook Guides, 7. Belt protector (from hook)/ramp guide, 8. Parcel centering adjustor (piston), 9. Parcel catching net, 10. Direction of movement, 11. Drone, 12. Winch Line, 13. Line puck (a.k.a. winch cable puck), and 14. Multi-hook/magnet/attachment mechanism.

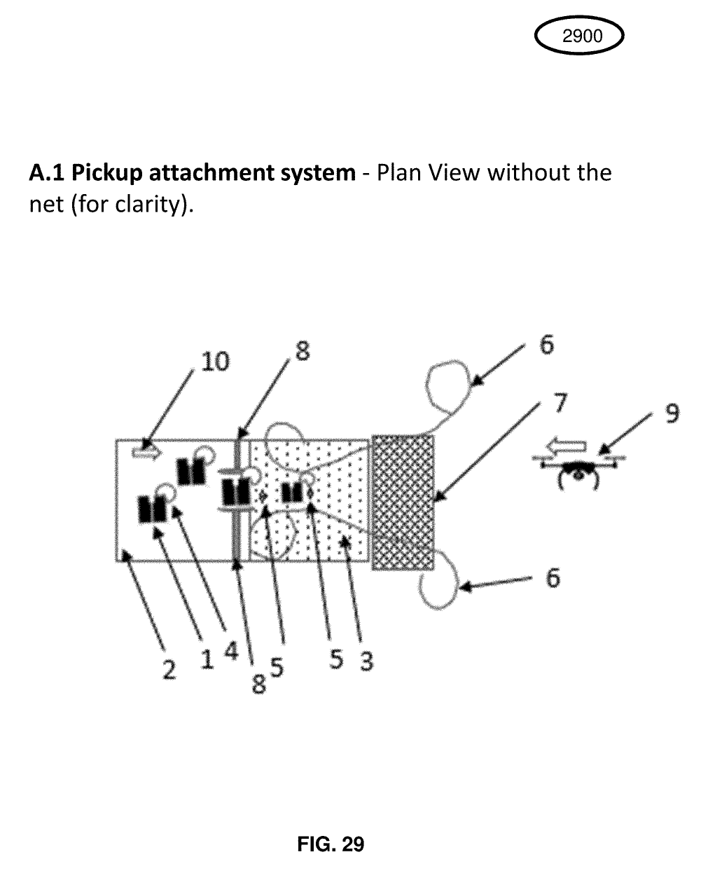

FIG. 29 illustrates a Plain view [A.1] illustrating an embodiment with a Box Pickup attachment system—without the net (for clarity). This view includes: 1. Box with gills, 2. Conveyor belt (stubbed or normal), 3. Conveyor belt (stubbed), 4. Attachment loop, 5. Scanner eye for knowing parcel position, 6. Line/Hook Guides, 7. Belt protector (from hook)/ramp guide, 8. Parcel centering adjustor (piston), 9. Drone, and 10. Direction of movement symbol.

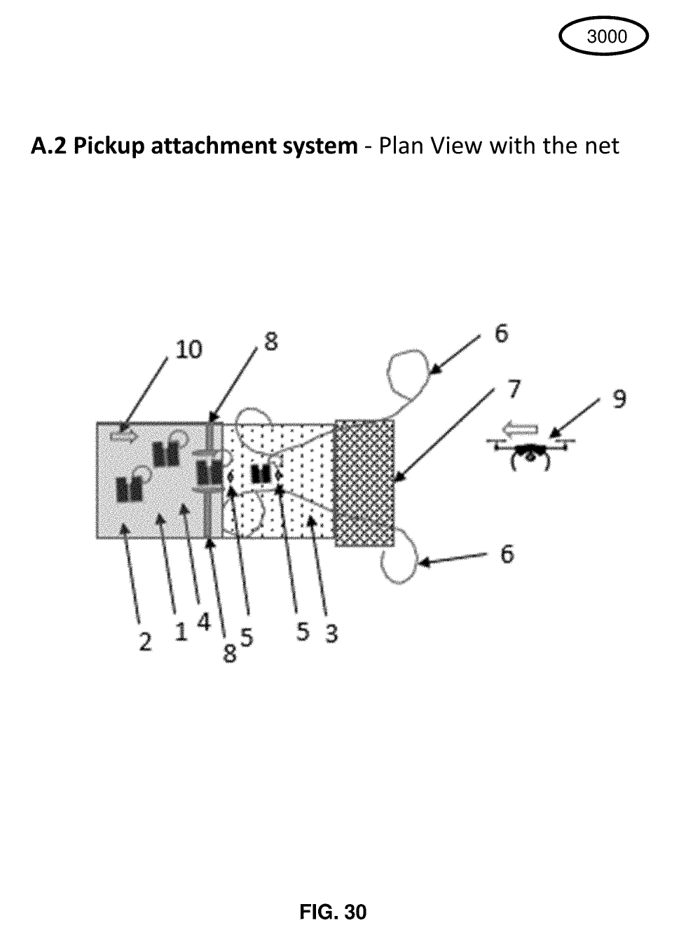

FIG. 30 illustrates a Plan View [A.2] illustrating an embodiment with a Box Pickup attachment system with the net (3000). This view includes: 1. Box with gills, 2. Conveyor belt (stubbed or normal), 3. Conveyor belt (stubbed), 4. Attachment loop, 5. Scanner eye for knowing parcel position, 6. Line/Hook Guides, 7. Belt protector (from hook)/ramp guide, 8. Parcel centering adjustor (piston), 9. Drone, and 10. Direction of movement.

FIG. 31 shows a Section view [B.a1.] of an embodiment (3100) illustrating a Box Feeder System—(pickup belt waiting to be fed). This view includes: 1. Box with gills, 2. Height adjustable Conveyor belt (stubbed or normal), 3. Attachment loop, 4. Scanner eye for knowing parcel position, 5. Line/Hook Guides, 6. Belt protector (from hook)/ramp guide, 7. Direction of movement, 8. Drone, 9. Winch line, 10. Line puck (a.k.a. winch cable puck), 11. Multi-hook/magnet/attachment mechanism, 12. Elevator/conveyor belt (be it for feeding or removing parcels), and 13. Feeder Separator (OPEN).

Parcel is queueing and is scanned for identification (via image processing, markings, QR code etc.) and communicated to appropriate drone that the parcel to be received is the correct one. If communication with drone is unavailable then drone identifies parcel using its onboard tech. (through image processing or through appropriate markings on the parcel [e.g. QR codes]).

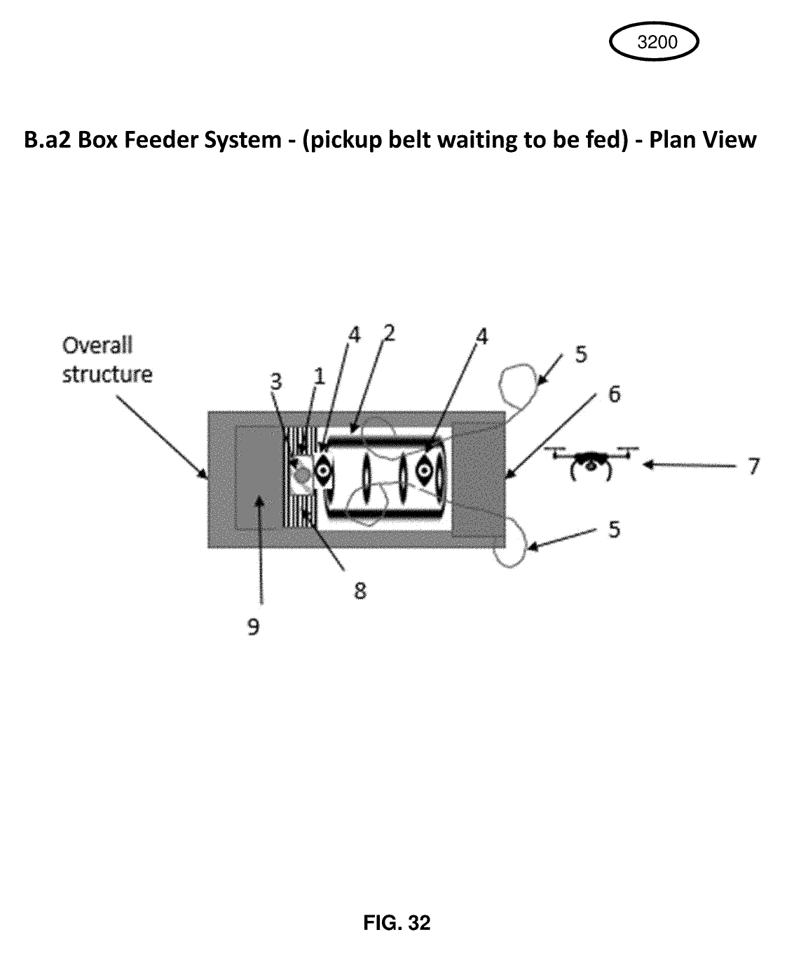

FIG. 32 [shows a Plan View [B.a2] of an embodiment (3200) illustrating a Box Feeder System—(pickup belt waiting to be fed). This view includes: 1. Box with gills, 2. Height adjustable Conveyor belt (stubbed or normal), 3. Attachment loop, 4. Scanner eye for knowing parcel position, 5. Line/Hook Guides, 6. Belt protector (from hook)/ramp guide, 7. Drone, 8. Elevator/conveyor belt (be it for feeding or removing parcels), and 9. Feeder Separator (OPEN).

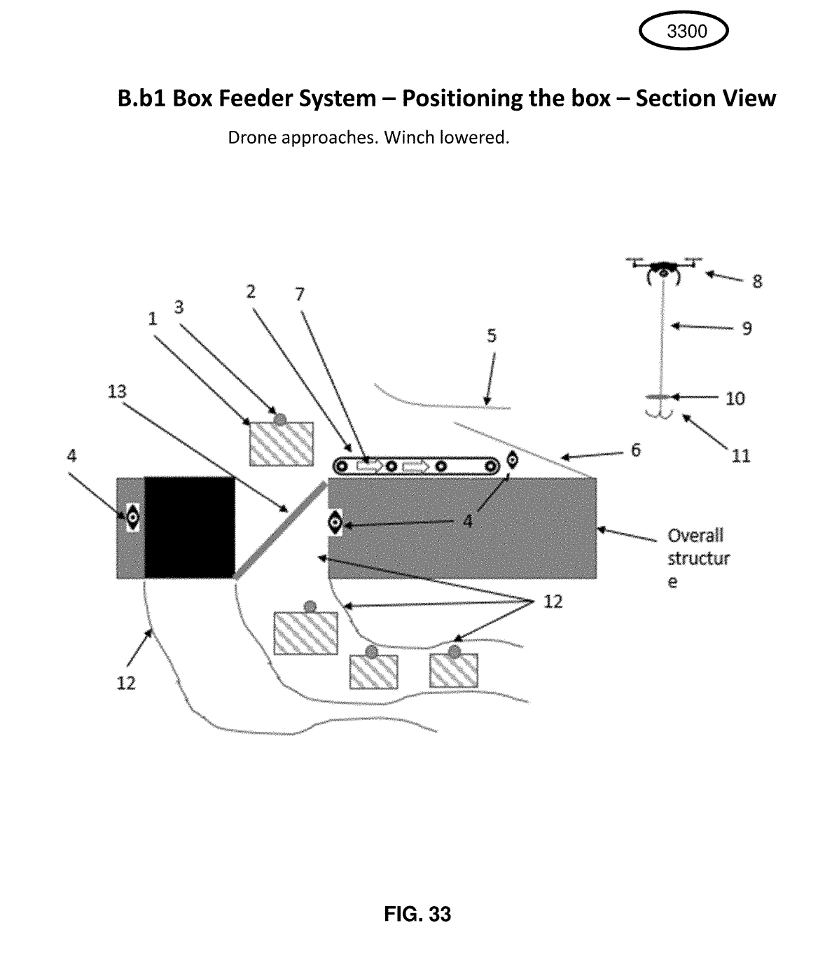

FIG. 33 shows a Section view [B.b1] of an embodiment with a Box Feeder System—Positioning the box (3300). This view includes: 1. Box with gills, 2. Height adjustable Conveyor belt (stubbed or normal), 3. Attachment loop, 4. Scanner eye for knowing parcel position, 5. Line/Hook Guides, 6. Belt protector (from hook)/ramp guide, 7. Direction of movement, 8. Drone, 9. Winch line (extended), 10. Line puck (a.k.a. winch cable puck), 11. Multi-hook/magnet/attachment mechanism, 12. Elevator/conveyor belt (be it for feeding or removing parcels), and 13. Feeder Separator (CLOSED).

FIG. 34 shows a Plain view [B.b2] of an embodiment with a Box Feeder System—Box positioned (3400). This view includes: 1. Box with gills, 2. Height adjustable Conveyor belt (stubbed or normal), 3. Attachment loop, 4. Scanner eye for knowing parcel position, 5. Line/Hook Guides, 6. Belt protector (from hook)/ramp guide, 7. Drone, 8. Feeder Separator (CLOSED), and 9. Drop area for parcels that failed to attach. Moving parcels for reprocessing.

FIG. 35 shows a Section view [B.c1] of a Box Feeder System—Box positioned and hooked (3500). This view includes: 1. Box with gills, 2. Height adjustable Conveyor belt (stubbed or normal), 3. Attachment loop, 4. Scanner eye for knowing parcel position, 5. Line/Hook Guides, 6. Belt protector (from hook)/ramp guide, 7. Direction of movement, 8. Drone, 9. Winch line (extended), 10. Line puck (a.k.a. winch cable puck), 11. Multi-hook/magnet/attachment mechanism, 12. Elevator/conveyor belt (be it for feeding or removing parcels), and 13. Feeder Separator (OPEN).

Drone has approached and identified structure as well as correctly identified that the parcel to be received is the correct one (through image processing or through appropriate markings on the parcel (e.g. QR codes). Parcel hooked.

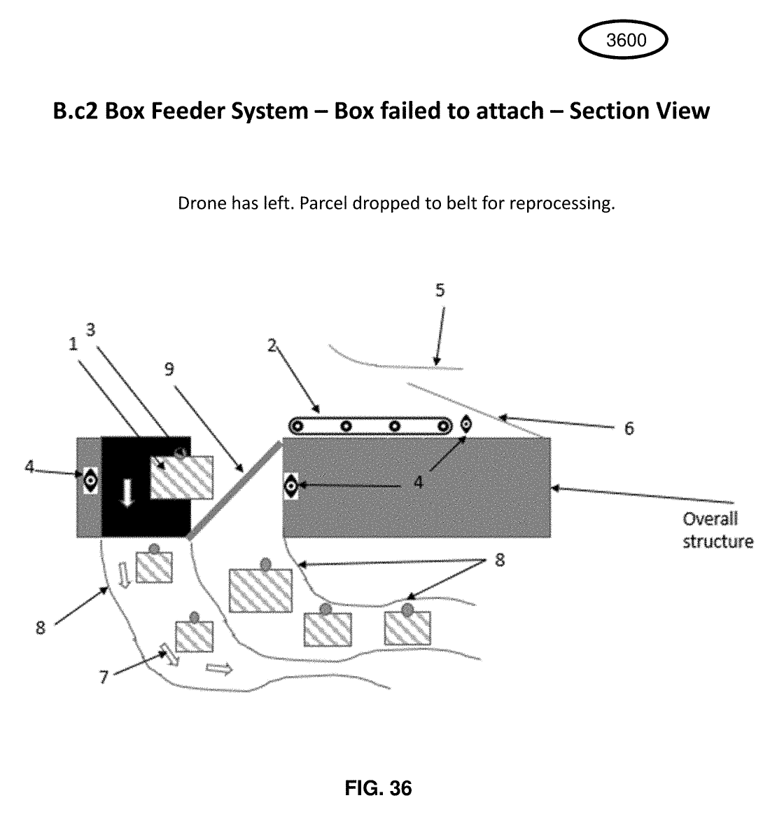

FIG. 36 shows a Section view [B.c2] Box Feeder System—Box failed to attach (3600). This view includes: 1. Box with gills, 2. Height adjustable Conveyor belt (stubbed or normal), 3. Attachment loop, 4. Scanner eye for knowing parcel position, 5. Line/Hook Guides, 6. Belt protector (from hook/ramp guide, 7. Direction of movement, 8. Elevator/conveyor belt (be it for feeding or removing parcels, 9. Feeder Separator (CLOSED).

Drone has left. Parcel dropped to belt for reprocessing.

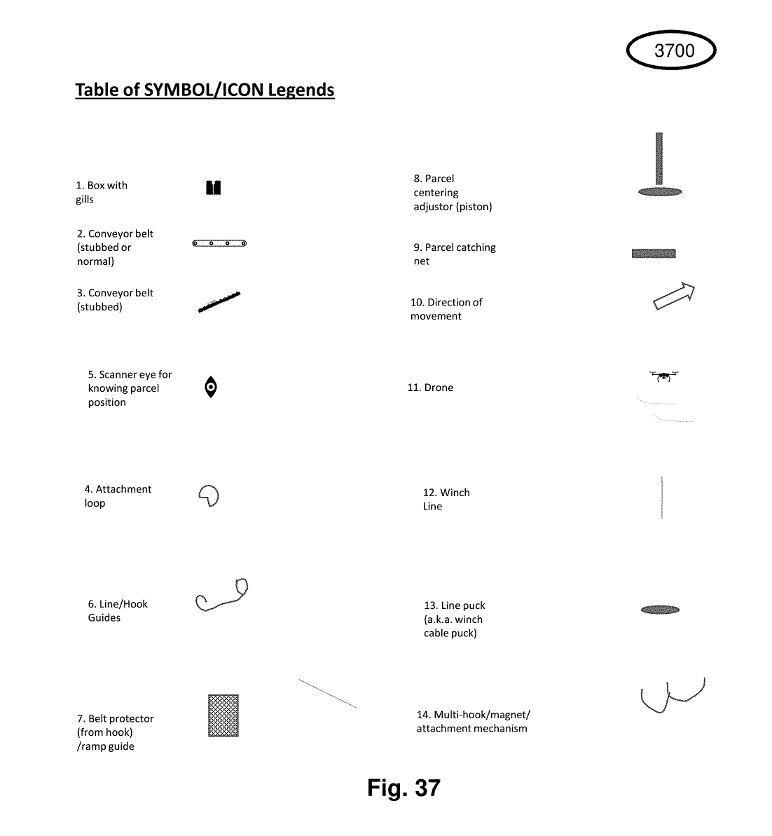

FIG. 37 is a Legends Table identifying some of the symbols/icons used on the above figures (3700).

### ADVANTAGES OF THE EMBODIMENTS

After collection, the dronespot owner/handler can process the parcel as normal, except that there is no need for code exchange to ensure safe delivery since parcel dropoff will be confirmed by the software of the drone.

Even if the drone were to fall (while taking ‘aim’ before releasing the parcel) the drone would fall onto the net, thus minimizing damage to it. The parcel would also be safe. Another advantage is time-saving, since there is no need for the drone to descend for dropoff and re-ascend for fly-away. A further benefit is the ability to simultaneously collect multiple parcels and have them funneled to specific processing/collection points. In addition, our solution has the benefit of minimization of queuing times and associated issues (as noted above) since the drones will only have to remain up in the air for a fraction of the time.

### CONCLUSION

While the present invention is described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

For example, a POSITAS would appreciate that the present invention may include embodiments in which incorporated control elements may be configured as a computer system, a method, or a computer program product. Various embodiments may thus be implemented in hardware, firmware, software, or a combination of forms. Particular embodiments may be in the form of one or more computer program products (including instructions/software/machine-readable code). Such program products may be pre-loaded on a computing device, downloadable through a communications network, or they may be encoded on computer-readable storage media. Moreover, as used herein, the terms storage device/media or memory should be understood to include a single medium or plural media, a centralized or distributed database, and/or associated caches and servers). Various computer-readable storage media may be utilized including, but not limited to: hard disks, compact disks, DVDs, optical and magnetic media, solid state memories, and or other machine accessible storage devices. Also, some embodiments may incorporate web-implemented computer software, which may be centralized or may be distributed (e.g., functionally or geographically).

What is claimed is:

1. A package delivery system comprising:
electronic controller means operatively connected to:
one or more delivery drones or unmanned aerial vehicles (“UAVs”), configured for performing one of flying, hovering and carrying a parcel, responsive to signals from the controller;
one or more sending dronespots configured for dispatching parcels, responsive to signals from the controller;
a parcel pickup apparatus affixed to the drones and configured with a retractable assembly for attaching parcels to a hovering drone while the UAV is still airborne; and
a parcel loading apparatus, at said sending dronespots, configured to move and guide parcels into position for engagement with the parcel pickup apparatus;
wherein delivery drones can pick up parcels from dispatching dronespots without having to land.

2. A package delivery system comprising electronic controller means operatively connected to:
one or more delivery drones or unmanned aerial vehicles (“UAVs”), adapted for flying, hovering and carrying a parcel, responsive to signals from said controller;
one or more receiving dronespots, configured for receiving or collecting parcels, responsive to signals from said controller;
targeting means for guiding a package carrying drone to, and identifying, a safe drop zone above a receiving dronespot designated said controller;
parcel release means, for dropping parcels into a designated drop zone;
parcel catching net structures, at said dronespots, configured to capture and collect one or more parcels for processing;
whereby drones can deliver parcels to receiving dronespots without having to land.

3. A package delivery system comprising electronic controller means operatively connected to:
one or more delivery drones or unmanned aerial vehicles (“UAVs”), adapted for flying, hovering and carrying a parcel, responsive to signals from said controller;
one or more receiving dronespots, configured for receiving or collecting parcels, responsive to signals from said controller;
payload dropping means for releasing parcels, and/or drones themselves, into an identified drop zone above a designated receiving dronespot;
adjustable net structures, at said receiving dronespots, configured for catching one or more parcels and/or catching one or more delivery drones;
whereby parcels can be received for processing while the drone is still airborne, and/or delivery drones can be captured for servicing.

4. A package delivery system comprising electronic controller means operatively connected to:
one or more delivery drones or unmanned aerial vehicles (“UAVs”), configured for flying, hovering and carrying a parcel, responsive to signals from said controller;
one or more first dronespots or hubs, configured for dispatching parcels, responsive to signals from said controller;
one or more second dronespots, configured for receiving parcels and/or drones, responsive to signals from said controller;
parcel pickup apparatus, affixed to said drones, configured with a retractable assembly for attaching parcels to a hovering drone while the UAV is still airborne;
parcel loading apparatus, at said first dronespots, configured to move and guide parcels into position for engagement with the parcel pickup apparatus;
payload dropping means for releasing parcels, and/or drones themselves, into an identified drop zone above a designated second dronespot;
adjustable net structures, at said second dronespots, configured for catching one or more parcels and/or catching one or more delivery drones;
whereby delivery drones can pick up parcels from sending dronespots, and dropoff parcels and/or drones at receiving dronespots, without having to land at either location, and/or delivery drones can be captured for servicing at receiving dronespots.

5. A parcel delivery system as in claim 4, wherein said second dronespots further comprise parking/docking/locking mechanisms and logic means for securing drones at said dronespots.

6. A parcel delivery system as in claim 4, wherein said second dronespots further comprise mechanisms and means for recharging and/or refueling power sources for delivery drones.

7. The parcel delivery system of claim 4, wherein the configuration of the catch-nets can be dynamically varied by said controller based on dronespot geo-spatial features.

8. The parcel delivery system of claim 4, wherein the configuration of the nets can be dynamically adjusted by said controller based on mass/density and other physical characteristics of the parcel to be dropped into the net.

9. The parcel delivery system of claim 4, wherein the height of the drop and the configuration of said nets can be dynamically adjusted by said controller based on environmental conditions such as windspeed, weather, time, traffic, etc.

10. The parcel delivery system of claim 4, wherein the net is part of a height adjustable moving conveyor belt mechanism for transporting the parcels from a landing point to a collection area.

11. The parcel delivery system of claim 4, wherein said parcel pickup and parcel loading apparatuses comprise electro-mechanical devices responsive to signals from said controller.

12. The parcel delivery system of claim 4, wherein plural drones may be in hover-and-drop mode over a target dronespot simultaneously, and there are plural drop points and/or collection points, on the net.

13. The parcel delivery system of claim 4 wherein, responsive to signals from said controller, the payload dropping apparatus can be dynamically reconfigured to release the parcel at a height when the drone is above or below the rim, or upper level, of the net.

14. The parcel delivery system of claim 4, wherein the net is attached to hooks or a winch/pulley mechanism affixed to the wall of a building and/or affixed to a plurality of poles.

15. The parcel delivery system of claim 4, wherein the parcel catching apparatus is configured so as to effectuate gravity feed, of dropped parcels, from a parcel landing point, along an extended net, to a collection point.

16. The parcel delivery system of claim 4, wherein the net is an extendable material which can be collapsed/rolled up for storage or rolled out to a desired size/shape for catching parcels or drones.

17. The parcel delivery system of claim 4, wherein a motor is operatively connected to power a winch/pulley for collapsing/extending said net, responsive to signals from said controller.

18. The parcel delivery system of claim 4, wherein a handcrank or other manual or mechanical device is operatively connected to power a winch/pulley for collapsing/extending said net, responsive to signals from said controller.

19. The parcel delivery system of claim 4, wherein the parcel catching apparatus comprises a net with calculated slack attached to a wall at a first elevation, and attached to poles at a second higher elevation, so that dropped parcels/drones slide at calculated rates from their landing point on the net, to a collection point at the first elevation.

20. The parcel delivery system of claim 4, wherein said parcel capture apparatus comprises line puck/winch-cable puck and a multi-hook/magnetic attachment mechanism.

21. The parcel delivery system of claim 4, wherein said parcel loading apparatus, at the second dronespots, comprises plural line guides and ramp guides, for guiding the parcel loading apparatus to an attachment/hooking point above the parcel.

22. The parcel delivery system of claim 4, wherein said dronespots comprise a recovery box, or failed attachment drop area, for channeling parcels, which did not get hooked by the parcel pickup apparatus, for reprocessing.

23. The parcel delivery system of claim 22, wherein said second dronespots comprise robotic or other electro-mechanical means for channeling parcels from the failed attachment drop area, a conveyor belt for reprocessing.

24. The parcel delivery system of claim 4, wherein said first & second dronespots comprise control units with computer processing means communicatively coupled to the controller, delivery drones and dronespot Owner/operator.

25. The parcel delivery system of claim 1, wherein said parcel loading apparatus includes scanner eyes for sensing parcel position on a stubbed or normal conveyor belt.

26. The parcel delivery system of claim 1, wherein said parcel loading apparatus includes parcel centering adjustor devices.

27. The parcel delivery system of claim 1, wherein said parcel loading apparatus includes a height adjustable conveyor belt.

28. The parcel delivery system of claim 4, wherein said parcel pickup and loading apparatus includes feeder-separator apparatus, which may be closed or open, responsive to action by the DSC or the DS operator.

29. The parcel delivery system of claim 4, wherein said parcel pickup and loading apparatus includes an elevator height adjustable/conveyor belt adapted for feeding and/or removing parcels.
